(19) United States
(12) Patent Application Publication
(10) Pub. No.: US 2014/0222493 A1
(43) Pub. Date: Aug. 7, 2014

(54) PROCESS MANAGEMENT SYSTEM, METHOD, AND COMPUTER-READABLE MEDIUM

(71) Applicant: UNI-B SOLUTIONS LLC, Chicago, IL (US)

(72) Inventors: Binu MOHAN, Woodridge, IL (US); Satyanarayana Reddy KAMASANI, Deerfield, IL (US)

(73) Assignee: UNI-B SOLUTIONS LLC, Chicago, IL (US)

(21) Appl. No.: 13/827,226

(22) Filed: Mar. 14, 2013

Related U.S. Application Data
(60) Provisional application No. 61/760,445, filed on Feb. 4, 2013.

(51) Int. Cl. G06Q 10/06

(52) U.S. Cl. CPC G06Q 10/06316
USPC 705/7.26

(57) ABSTRACT

A system, method, and computer-readable medium storing instructions for managing workflows including a business logic layer including (a) a workflow creator configured to define a unified workflow by combining steps of at least two workflows, the unified workflow having associated workflow data including (i) step data associated with each of the steps, the step data including track data that associates each of the steps with a track, and (ii) a business rule, the workflow data having been imported from a non-uniform data format and converted to a uniform data format, (b) a business rules engine configured to select and apply the business rule to the workflow data, and (c) a workflow manager configured to manage the unified workflow based on the selected and applied business rules; and a presentation layer configured to output information regarding the managed unified workflow to a display medium.

### CROSS-REFERENCE TO RELATED APPLICATION

This nonprovisional application claims the benefit of U.S. Provisional Application No. 61/760,445, filed Feb. 4, 2013.

### BACKGROUND

Every organization establishes operating processes to address organizational needs. To address varying operating needs, the processes differ from each other in motivation, applicability and context, specification, urgency, flexibility, impact (both desired and actual), and frequency.

Needs are often unanticipated and flexible organizations adapt quickly by establishing new processes to address new or changing needs. However, especially during periods of rapid organizational growth or in the face of abbreviated timelines, creating and managing new and established processes can be complicated due to interdependencies, conflicting or scarce resources, and other reasons that complicate process delivery, execution, and completion. Processes can involve multiple activities, actors, goals, and resources and artifacts. These complications can lead to inconsistencies and inefficiencies in the organization, which increases operational expenses and resource requirements. To adapt, organizations create methods and systems for delivering, executing, and completing the processes to ensure that the processes are aligned to organizational protocols, rules, and needs.

### SUMMARY

Embodiments of the invention provide a flexible process (hereinafter referred to as a workflow) management system, method, and computer-readable medium that allow organizations to improve the efficiency of existing workflows and improve the delivery of organizational products and services.

Embodiments include: a business logic layer including a workflow creator configured to define a unified workflow by combining steps of at least two workflows, the unified workflow having associated workflow data including (i) step data associated with each of the steps, the step data including track data that associates each of the steps with a track, and (ii) a business rule, the workflow data having been imported from a non-uniform data format and converted to a uniform data format, a business rules engine configured to select and apply the business rule to the workflow data, and a workflow manager configured to manage the unified workflow based on the selected and applied business rules and a presentation layer configured to output information regarding the managed unified workflow to a display medium.

Embodiments can cause the computer to further function as a request-response handler configured to (i) accept a request from an external system, the request containing encrypted request data, (ii) forward the request to the business logic layer, (iii) receive a response from the business logic layer, the response containing encrypted response data, and (iv) return the response to the external system.

Embodiments can cause the computer to further function as a data storage layer configured to store the workflow data, wherein the data storage layer and business logic layer are configured not to store a decrypted copy of the encrypted request data or the encrypted response data.

The step data for a step can include (i) a trigger condition which, when met, causes the associated step to be triggered, and (ii) a termination condition which, when met, causes the associated step to be terminated.

The business rules engine can be configured to select and apply a business rule to the step data to change the trigger condition or the termination condition based on the track data. The business rules engine can be configured to select and apply a business rule to the step data to change the trigger condition or the termination condition based on the step data or step data of another step. The business rules engine can be configured to select and apply a business rule to the step data to change the trigger condition or the termination condition based on a timing of at least one of when the unified workflow is initiated, when another step triggers, and when the another step terminates.

Embodiments can cause the computer to further function as a group rule set manager configured to manage a plurality of sets of group rules, each set being associated with at least one of a plurality of assignable entities. The at least one of the plurality of assignable entities can be defined based on a shared attribute of the assignable entities.

The presentation layer can be configured to output information regarding the managed unified workflow that is related to a workflow requesting user upon request. The presentation layer can be further configured to output a selection dialog that allows a requesting user to either select a defined tag or create an undefined tag to associate with a workflow request. The presentation layer can be further configured to output an interface that allows an initiating user to view and initiate a plurality of workflows that the initiating user is authorized to initiate based on an employee group of which the initiating user is a member.

Embodiments can cause the business logic layer can associate or reassociate a step with a track based on a selection of the track by an assignee or approver of another step.

Embodiments can cause the track data to associate each of the steps with at least one of a plurality of tracks, and each of the plurality of tracks can correspond to one of a plurality of assignable entities responsible for performing the step(s) in the track. The plurality of assignable entities can each have a plurality of members, the members can have a common entity attribute, and the common entity attribute of each track can be different from the common entity attribute of other tracks. The plurality of assignable entities can be entities that are capable of executing a step and are selected from a group consisting of a person, a machine, a system of machines, a department and an office.

Embodiments can cause the step data to include track data that associates each of the steps with one track of a plurality of tracks, the track corresponds to one of a plurality of assignable entities responsible for performing the step(s) in the track. The unified workflow can proceed over steps in more than one track.

Embodiments further include: a method of managing a unified workflow for performing a task, the unified workflow combining steps of at least two workflows, the unified workflow having associated workflow data including step data associated with each of the steps, the step data including track data that associates each of the steps with one track of a plurality of tracks and the track corresponding to one of a plurality of assignable entities responsible for performing the step(s) in the track, the method comprising: assigning to the step data at least one of (i) a trigger condition which, when met, causes an associated step to be triggered, and (ii) a termination condition which, when met, causes the associated step to be terminated and linking the associated step with one or more other steps based on the assignment of step data.

Embodiments can cause the method to reassign at least one step to a different track, wherein reassigning at least one step is based on one of the step data of another step, the track data of another track and the track data of the track including the at least one step.

Embodiments can cause the method to manage the unified work flow including: reassigning the trigger condition and/or the termination condition of the associated step in the track to be associated with the one or more other tracks, eliminating at least one step of similar steps in one or more tracks or consolidating a plurality of steps into a single step.

Because of the flexibility and extensibility of embodiments, many business workflows can be managed by embodiments. For example, any paper-based process can be completely replaced and managed by systems of embodiments.

### BRIEF DESCRIPTION OF THE DRAWINGS

Various exemplary embodiments of a workflow management system to which aspects of the invention are applied will be described in detail with reference to the following drawings in which:

FIG. 1 is a schematic diagram showing an exemplary logical architecture representing a system of embodiments;

FIG. 2 is a block diagram of an exemplary multi-tier architecture that can support the system;

FIG. 3 is a schematic diagram showing an exemplary embodiment of the system running in a multi-tiered architecture;

FIG. 4 is a schematic diagram showing an exemplary hardened on-demand embodiment in which customer data is not stored outside of a protected silo;

FIG. 5 is a schematic diagram showing an exemplary hardened embodiment in which batch workflow data can be securely imported into or exported from the workflow management system;

FIG. 6 is a schematic diagram showing an exemplary multi-tenant embodiment that can manage separate logical database structures;

FIG. 7 is a schematic diagram showing an exemplary embodiment supporting downstream single sign-on (SSO);

FIG. 8 is a schematic diagram showing an exemplary authentication model of an embodiment;

FIG. 9A is a flow diagram illustrating an exemplary, simple linear business workflow such as a new-hire onboarding process showing each operating task when a new employee is hired in an organization;

FIG. 9B is a flow diagram illustrating an exemplary, simple linear business workflow such as a voluntary termination process showing each operating task when an employee voluntarily terminates employment with the organization;

FIG. 10 are flow diagrams illustrating the traditional approach to workflows;

FIG. 11 is a flow diagram illustrating an exemplary viewable instance of a single global workflow object that is created, managed, and maintained as a unified workflow according to an embodiment;

FIG. 12 is a schematic diagram showing an exemplary unified workflow object of an embodiment;

FIG. 13 is a schematic diagram showing an exemplary unified workflow object with steps that are associated with more than one track;

FIG. 14 is a schematic diagram showing an exemplary workflow with two tracks and shared steps;

FIG. 15A is a flow diagram illustrating an exemplary data import that populates assignable entity attributes into a database;

FIG. 15B is a flow diagram illustrating an exemplary group rule sets applied by the business rules engine of an embodiment;

FIG. 16 is a flow diagram illustrating an exemplary workflow execution algorithm based on a workflow object of an embodiment;

FIG. 17 is a flow diagram illustrating an exemplary linear unified workflow of an embodiment;

FIG. 18 is a flow diagram illustrating an exemplary parallel unified workflow of an embodiment;

FIG. 19 is a flow diagram illustrating an exemplary decision-based unified workflow of an embodiment;

FIG. 20A is a UI diagram showing an exemplary context-sensitive workflow initiator interface of an embodiment;

FIG. 20B is a UI diagram showing in further detail exemplary workflows that the director can initiate based on the director's employee groups and/or assignable entity attributes in the exemplary context-sensitive workflow initiator interface; and

FIG. 21 is a flow diagram illustrating an exemplary method for determining and displaying a context-sensitive workflow initiator interface of an embodiment.

FIG. 22 is a schematic diagram illustrating an exemplary display operating with a decision-based unified workflow.

### DETAILED DESCRIPTION

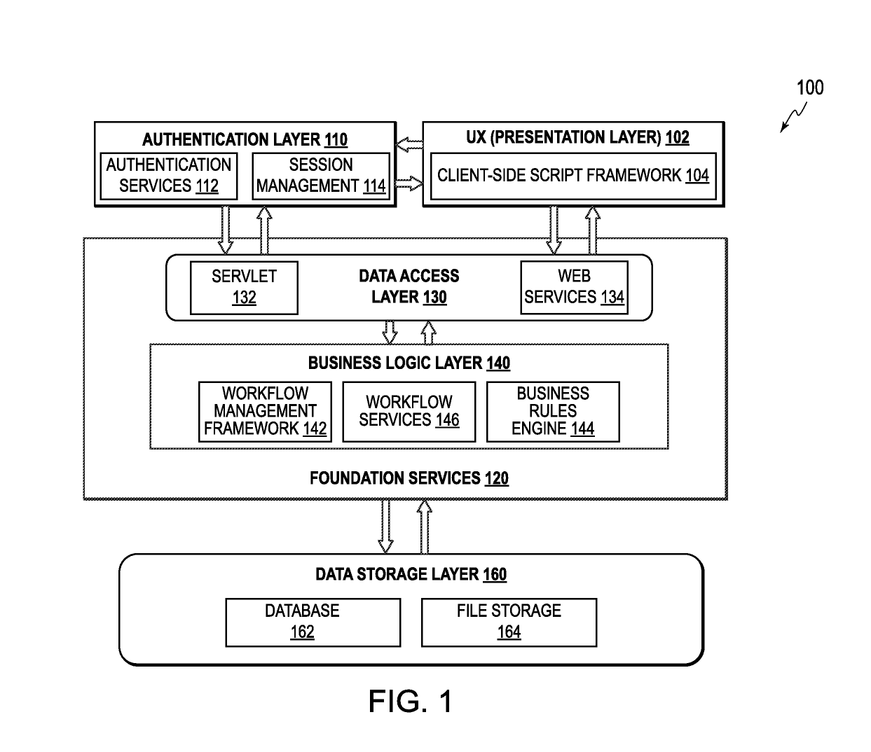

Embodiments of the invention are described below with reference to FIGS. 1-21.

Embodiments provide a system, method, and computer-readable medium for managing and automating multiple (and potentially an unlimited number of) disparate workflows. The disparate workflows can be managed and automated through a single system and application that is flexible enough to automate any paper-based, data-based, and/or task-based workflow with steps performed whether wholly or in part by any entity within an organization. Used herein, the term “disparate workflows” means any workflows that have at least one differing step or task.

Examples of disparate workflows that can be managed and automated include self-service workflows such as editing personal information and emergency contact information; employee transfers and cross-boarding requests; annual compliance; merit pay increase and bonus requests; direct deposit; new hire onboarding including orientation and training; employee termination and off boarding; expense reports; rewards programs; FMLA and leave requests; performance reviews; purchase order requests and invoice mapping; policy acknowledgements and sign-off; and talent assessments and candidate interviews. There are many systems and interfaces for managing some of the foregoing workflows including products by SAP, Oracle, LMS, Saba, SumTotal, ADP, Paychex, Silkroad, Taleo, XM, Concur, Sharepoint, and others.

Embodiments provide for setting up or allowing administrator(s) to set up a unified workflow based on the disparate workflows and any additional business logic that drives the workflow (for example, in an onboarding workflow for a new employee, preparing an offer letter or employee contract prior to setting up payroll information), importing data relating to the unified workflow (for example, converting paper forms and transactions into a format that is understandable by embodiments), automating the unified workflow, capturing information pertaining to execution of the tasks of the unified workflow (for example, form data pertaining to 401K enrollment), and/or providing the information to a presentation layer or external system. The features of the embodiment can be provided through a single user interface or portal that is preferably web-based.

Embodiments provide many advantages over the prior art. Embodiments are highly flexible because the embodiments are generally applicable to any workflows. Embodiments are high extensible because users can apply business rules to accommodate varying scenarios. Embodiments standardize and add consistency to disparate workflows. Embodiments are faster to implement because templates for unified workflows, steps, tracks, and business rules can be provided. Embodiment lower maintenance costs, because users can configure, reconfigure, and customize the workflows.

Embodiments provide for highly flexible and extensible system and data architectures and presentation layer described further below.

1. System Architectures

The system architectures of embodiments will now be described with reference to the following figures.

FIG. 1 is a schematic diagram showing an exemplary logical architecture representing a system 100 of embodiments. The system 100 includes logically distinct layers and components of features of embodiments, for example, the software components of a multi-tier web-based application. The system 100 can include: a UX or presentation layer 102 that includes a client-side script framework 104; an authentication layer 110 with authentication services 112 and session management 114; foundation services 120 including a data access layer 130 with servlet 132 and web services 134, and a business logic layer 140 with workflow management framework 142, business rules engine 144, and workflow services 146; and a data storage layer 160 with database 162 and file storage 164.

Each layer and component within the system 100 can represent a set of instructions stored on a computer-readable medium. The computer-readable medium is preferably tangible and non-transitory. The computer-readable medium can be any volatile or non-volatile storage medium such as a RAM, a hard disk drive, removable media, EEPROM, flash memory, holographic memory, or any combination thereof. The instructions can be stored in any computer-readable format, whether as object code or source code, and execution of the instructions can include compilation, interpretation, or anything else that prepares code for execution by a processor. The processor can be any hardware processor that can execute computer code including a CPU, an MPU, an ASIC, a (GP) GPU or VPU, a PPU, a DSP, an FPGA, or any combination thereof.

The inter-layer and inter-component communication of the system 100 can use any application level messaging protocol or specification, whether synchronous or asynchronous, that provides for data exchange to produce a format understood by the receiver of the message. For example, the layers and components can communicate with one another directly using JSON messages or indirectly using message queues (e.g., SonicMQ) or a bus. Further, a variety of communications can be used between the layers and components and even between the same two layers and/or components. The communication can be encrypted or otherwise secured, for example, using SSL or TLS.

The presentation layer 102 can allow a user to provide input to and receive output from the workflow management system. On the front end, the presentation layer 102 can receive input from and return output to a user through a web-based interface or any other interface that facilitates communication over a network such as the Internet. The web-based interface can be a webpage that is formatted for a specific platform, such as a class of devices and/or web browsers. The web-based interface can communicate over HTTP/S. Alternatively, a single request or response may have both HTTP and HTTPS elements. The communication can use any transport layer protocol such as TCP, UDP, DCCP, SCTP, RSVP, or combination thereof.

The web-based interface preferably employs a lightweight and fast client-side script framework 104, such as JavaScript, that allows the user to execute client-side scripts to manipulate data and the presentation of data on the client-side machine. This reduces the amount of processing and network traffic handled by the process management system and also allows each user to download and execute client-side scripts that can be customized to the user's particular environment. The presentation layer 102 can employ any method for detecting the browser and/or platform type in order to ensure that the response data is properly formatted for presentation, including the JavaScript BrowserDetect, Browser, and navigator objects; HTTP GET/POST methods; or jQuery browser object.

On the back end, the presentation layer 102 can communicate with the data access layer 130 indirectly through the authentication layer 110 or directly with the data access layer 130 if no authentication and authorization is required.

The authentication layer 110 can authenticate and/or authorize users of the workflow management system. The authentication layer 110 can either communicate with users through the presentation layer 102 or communicate directly with users through an API (not shown). The authentication services 112 can include authorization services provided by an authority server. The authority server can exchange authentication and/or authorization information with the presentation layer 102 and/or the data access layer 130 using any specification that allows the authentication layer 110 to appropriately authenticate the user and authorize the user to read, modify, and/or create resources. For example, the authority server can employ the SAML or OpenID specifications for authentication data exchange.

Once the user is authenticated and authorized to access resources (through the data access layer 130), the session management 114 can manage session initiation and termination. For example, the session management 114 can create a validation token that is associated with the user's session. The validation token allows the user to continue to communicate with the workflow management system without having to re-authenticate or re-authorize every new request within the session. The session management 114 can revoke or destroy the validation token to terminate the session.

The authentication layer 110 can communicate directly with users through a variety of known methods without invoking the functions of the presentation layer 102. For example, external systems can batch datasets to and/or export datasets from the data access layer 130 through the authentication layer using HTTP/S GET/POST requests.

The data access layer 130 can be considered part of the foundation services 120 and can provide a channel for users to access data. The servlet 132 can include a web container such as Apache Tomcat, Jetty, JBoss, WebLogic, WebSphere or any other web container that manages servlet instances. The data access layer 130 can also include web services 134 that allow bi-directional web-based communications, for example, using SOAP, WSDL, or any other specification that allows for the exchange of structured information over the web.

On the front end, the data access layer 130 can receive requests and send responses through the authentication layer 110 and/or the presentation layer 102. Alternatively, the data access layer 130 can receive requests and/or send responses that bypass the authentication layer 110 and the presentation layer 102 if authentication, authorization, and presentation are not needed. For example, the data access layer 130 can use a web services API for data import and/or export. On the back end, the data access layer 130 can communicate with the business logic layer 140 or with the data storage layer 160.

On the front end, the business logic layer 140 can receive data from and/or return data to the data access layer 130. The business logic layer 140 processes business logic that drives business workflows. For example, requests from the data access layer 130 can invoke the functions of the workflow management framework 142, the business rules engine 144, and/or the workflow services 146.

The workflow management framework 142 can manage the workflow framework by, for example, processing requests for creating, modifying, and deleting workflows. The workflow management framework 142 can use a known flow framework platform such as Amazon's AWS Flow Framework.

The business rules engine 144 can manage the business rules, for example, evaluating a workflow status and determining which rule(s) to apply. The business rules engine 144 can also process requests for creating, modifying, or deleting rules via a user request or preprogrammed intelligence. The business rules engine 144 can use a known business rules management system such as OpenRules's Business Rules Engine.

The workflow services 146 can manage the workflows, for example, managing communications between workflows and manipulating workflow data upon various triggers based on the business rules.

On the back end, the business logic layer 140 can communicate with the data storage layer 160.

On the front end, the data storage layer 160 can communicate with the foundation services 120. The data storage layer 160 can process data storage, modification, and retrieval requests for data stored in the database 162 and/or for files stored in the file storage 164.

Any of the foregoing layers or components therein can be provided on one or more physical computing machines and can be spread through a variety of locations. For example, an administrator's security requirements may mandate that authentication and authorization services be provided in a site subject to full control by the administrator. In this situation, the authentication layer 110 can be provided as a separate computing unit within the administrator's protected network, while the remainder of the workflow management system is provided on computing units in a remote location or multiple remote locations.

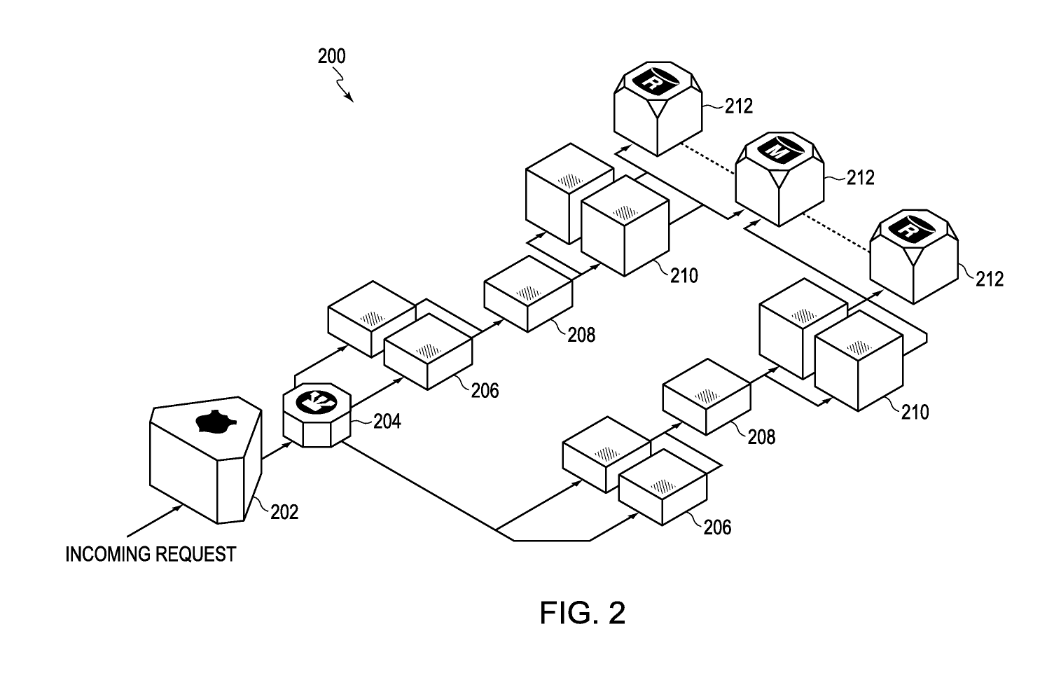

FIG. 2 is a block diagram of an exemplary multi-tier architecture 200 that can support the system 100. In the multi-tiered architecture 200, an incoming web request can be routed by a domain name system 202 to a first tier load balancer 204. The first tier load balancer 204 can then direct the incoming web request to any of a number of web servers 206. The web servers 206 can then process the incoming web request and can forward an application server request based on the web request to a second tier of load balancers 208. The second tier of load balancers 208 can then forward the application server request to the application servers 210. The application servers 210 process the application server request and send queries to the databases 212. Any tier in the system can be replicated with multiple machines using data mirroring or striping for high availability or failover. The multiple machines can be real or virtual machines.

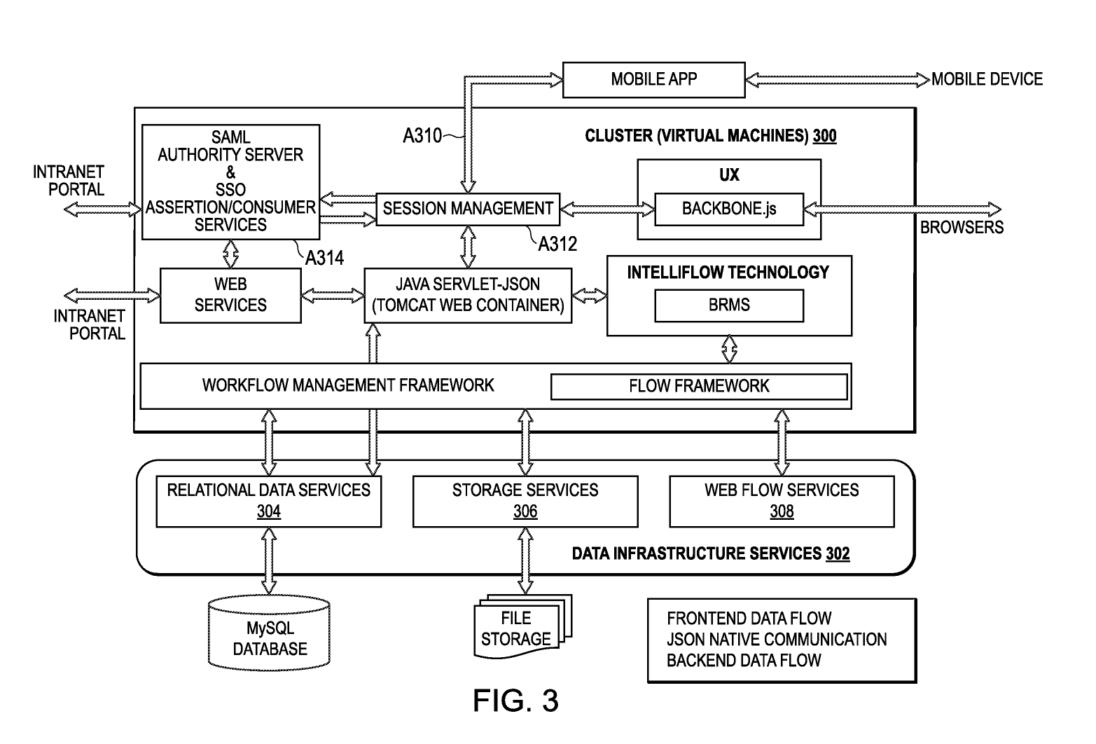

FIG. 3 is a schematic diagram showing an exemplary embodiment of the system running in a multi-tiered architecture, and in particular, showing the system running in a Software-As-A-Service (SaaS) configuration. A cluster of virtual machines 300 host specific embodiments of the presentation layer, the authentication layer, and the foundation services. The data access layer can have an additional layer of data infrastructure services 302 that can include relational data services 304, storage services 306, and web flow services 308.

In FIG. 3, the following exemplary flow occurs for authentication and authorization when the cluster of virtual machines 300 receives a request A310. First, the session is validated by session management A312 to check if the user making the request A310 is already authenticated. If so, the user's request is further processed. If not, the user is returned to a login page to enter credentials. Second at A314, the authentication layer reads all the posted values and determines the user and context, including the relevant processes, steps, and dashboards. Third at A314, the authentication layer verifies the authorization level of the user for the requested resource(s). If the user is authorized to use the requested resource(s), the resource(s) are retrieved and delivered. If the user is not authorized to use the requested resource(s), the resource(s) are not retrieved or delivered; subsequently, an error message can be returned to the user. Fourth, the workflow management framework determines whether the step associated with the request is complete. For example, if the request is a form post, the values submitted with the form are validated and saved to the database or external system. Fifth, the BRMS sends a completion signal to the flow framework (an example of the workflow services), which can then create or activate the next step in the database based on the process definition and applied business rules. Sixth, the next step becomes the current step, which is loaded by the system and a JavaScript Object Notation (JSON) is created based on data field definitions corresponding to the step. Seventh, the step is executed, and the cycle repeats.

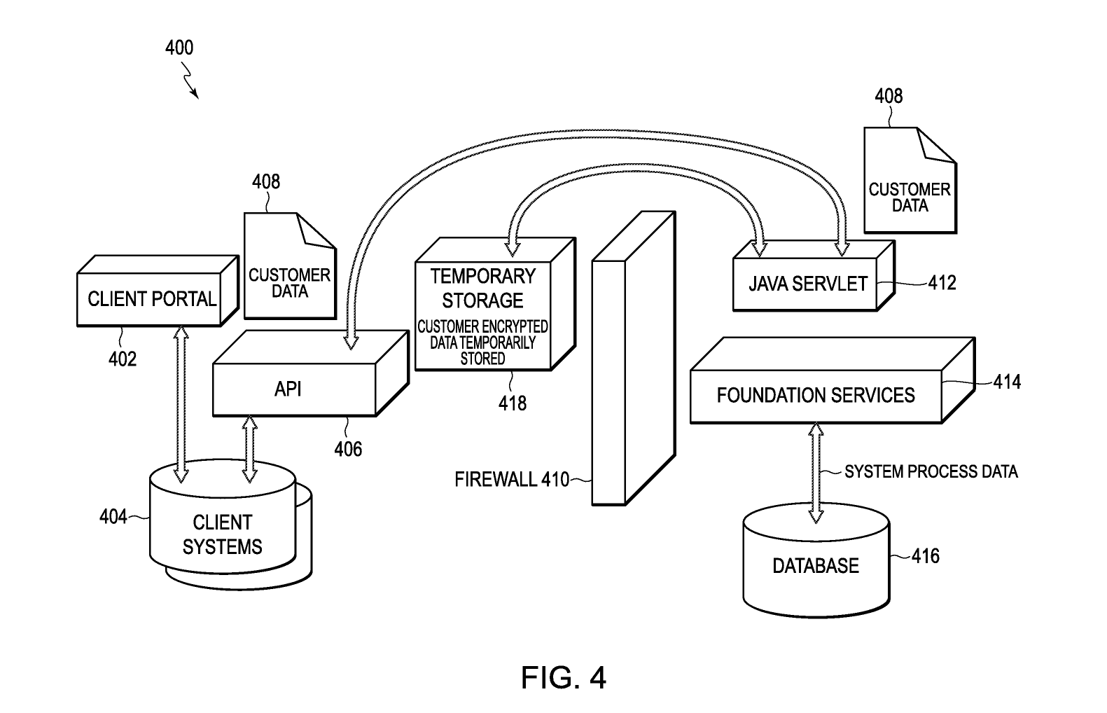

Even running in a SaaS configuration, the system can meet an organization's security requirements that certain sensitive data cannot be stored in an unencrypted form outside of the organization's firewall. FIG. 4 is a schematic diagram showing a hardened on-demand SaaS system 400 in which unencrypted customer data is not stored outside of a protected silo. A customer (or client) can be a single end-user, an administrator, or any organizational entity that uses the process management system. The customer can have security requirements that certain sensitive data, especially that relating to their workflows, cannot be stored in an unencrypted form anywhere outside of the customer's firewall(s).

In the on-demand system 400, the customer can create a request to access the process management system, for example, to execute a step in a workflow, through a client portal 402 on the front end. The client portal 402 can forward the request to backend client systems 404. The client systems 404 can translate the request through a provided API 406 into the relevant customer workflow data. The customer workflow data 408 can be encrypted before the API call is invoked or the API 406 can encrypt the customer workflow data 408. The API 406 can then invoke a secure HTTPS POST method containing the encrypted customer workflow data 408 to a Java Servlet 412 outside of the firewall 410. The Java Servlet 412 can then decrypt the encrypted customer workflow data 408 or the Java Servlet 412 can forward the encrypted customer workflow data 408 to the foundation services 414 for decryption and processing. The foundation services 414 can decrypt the encrypted customer workflow data 408 and/or process the decrypted data further by applying internal system process data through queries to the database 416. The processing can occur in real-time without ever storing the customer data on a non-volatile medium. To complete the processing, the foundation services 414 can create an encrypted response that is then returned to the protected silo inside of the firewall 410 through the Java Servlet 412. The encrypted response may be temporarily stored in temporary storage 418 for the customer to retrieve and may have a time out or be erased from temporary storage 418 upon retrieval.

The on-demand system 400 can use internal messaging, for example, web services calls and JSON native communication, on demand for inbound and outbound system and sensitive customer data so as to transit the sensitive customer data between physical or virtual machines in encrypted form only. The sensitive customer data can be decrypted and manipulated at a single logical component (e.g., foundation services 414 can run on a single machine) in memory before being re-encrypted. Thus, the sensitive customer data is never stored on a non-volatile medium of the system 400, thereby helping to ensure that sensitive customer data is not stored outside of the protected silo in an unencrypted form.

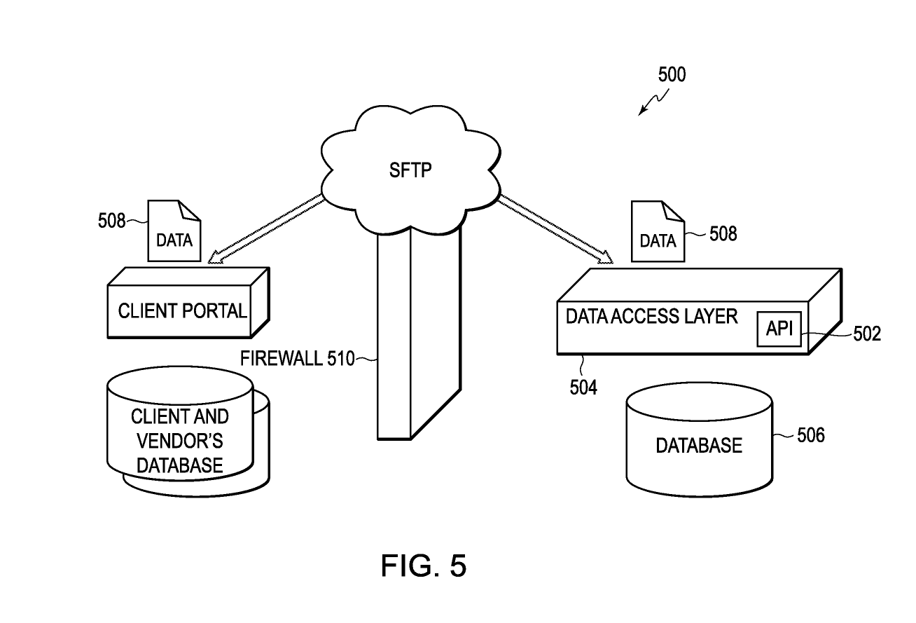

Even running in a SaaS configuration, the system can meet an organization's security requirements where certain sensitive data that is exported from within the organization's firewall must be exported securely, for example, in an encrypted format. FIG. 5 is a schematic diagram showing a hardened system 500 in which batch workflow data can be securely imported into or exported from the workflow management system. In the hardened system 500, the customer may have security requirements that certain sensitive data, such as ERP/HRIS data, cannot be transferred outside of the customer's firewall 510 in an unencrypted format.

In the hardened system 500, the customer (or client) can batch transfer sensitive customer data 508 through the firewall 510 over a secure file transfer protocol (SFTP) to or from the workflow management system. The user requesting the batch transfer can invoke an API 502 of the data access layer 504, which converts the sensitive customer data 508 into a uniform data format in the case of importing data into the database 506 or converts the uniform data format into a format requested by the user in the case of exporting data from the database 506.

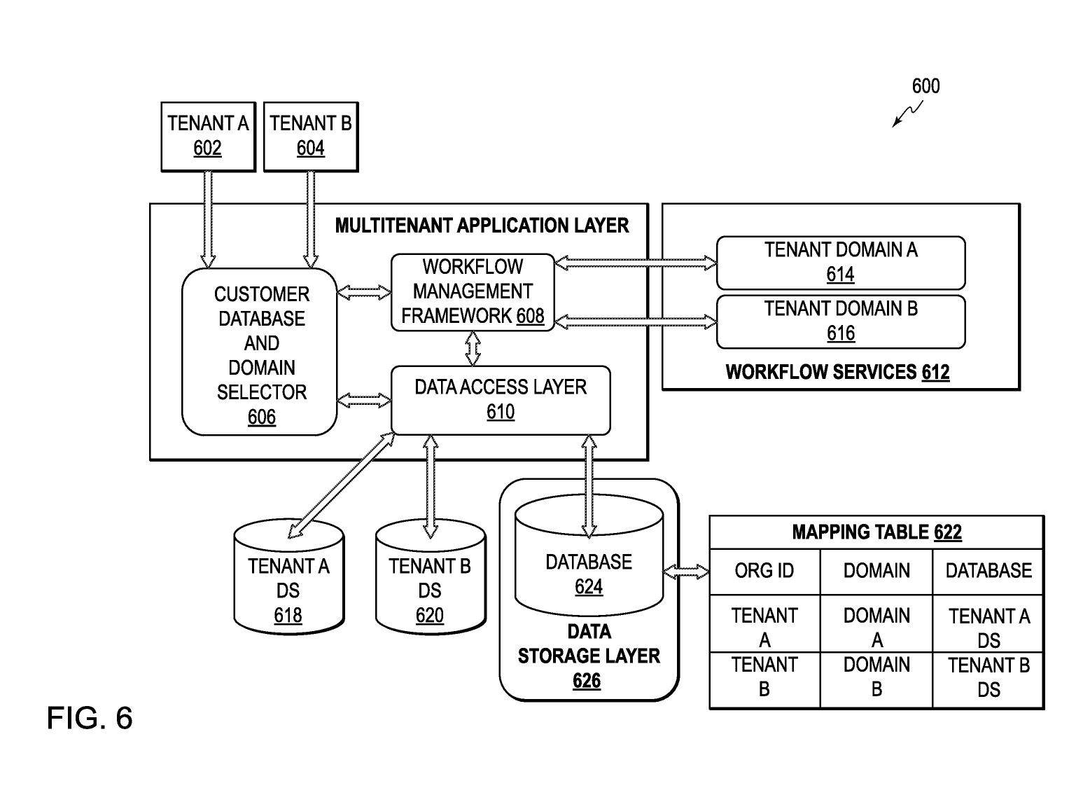

FIG. 6 is a schematic diagram showing a multi-tenant workflow management system 600 that can manage separate logical database structures. The multi-tenant workflow management system 600 allows a single instance of the system 600 to manage multiple tenants simultaneously, thus allowing for more efficient resource allocation. The mechanism for logically siloing customer data is transparent to the customer whose system only has to transmit the organization identifier without the customer having to install or execute additional software within the customer's network. The organization identifier (or a modified, but unique variation of the organization identifier) is maintained seamlessly to provide only the customer's data to the requesting customer.

In the multi-tenant embodiment, multiple tenants (or customers) may access the same logical workflow management system 600. The application layer supports multiple tenants 602-604 using a customer database and domain selector 606. Each tenant's request includes, in addition to normal request data, an organization identifier. The authentication layer (not shown) can process the request to authenticate each tenant and authorize each tenant to access information associated with the organization identifier of the request. The validated request can be forwarded with the organization identifier to the customer database and domain selector 606, which interfaces with the workflow management framework 608 and data access layer 610, both of which retain the organization identifier (or a modified, but unique, variation of it) in downstream requests. For example, the workflow management framework 608 can communicate with the workflow services 612 to ensure that customer data is not cross-contaminated by retaining the organization identifier with each transaction of the workflow services 612 so as to logically separate the data into respective domains 614-616. As another example, the workflow management framework 608 can communicate with the data access layer 610 to ensure that customer data is not cross-contaminated by retaining the organization identifier with each transaction of the data access layer 610. The customer data can be further siloed by storing the customer data into corresponding and logically separate data storages 618-620. The system 600 can include a mapping table 622 that can be stored in a logically separate database 624 as part of a data storage layer 626. The mapping table 622 can provide a mapping of the organization identifiers to their respective domains and data storages. The customer database and domain selector 606 can query the mapping table 622 through the data access layer 610 prior to authenticating, authorizing, and/or routing the customer's request—the query returns the corresponding domain 614 or 616 and/or database 618 or 620 to be associated thereafter with the corresponding customer data.

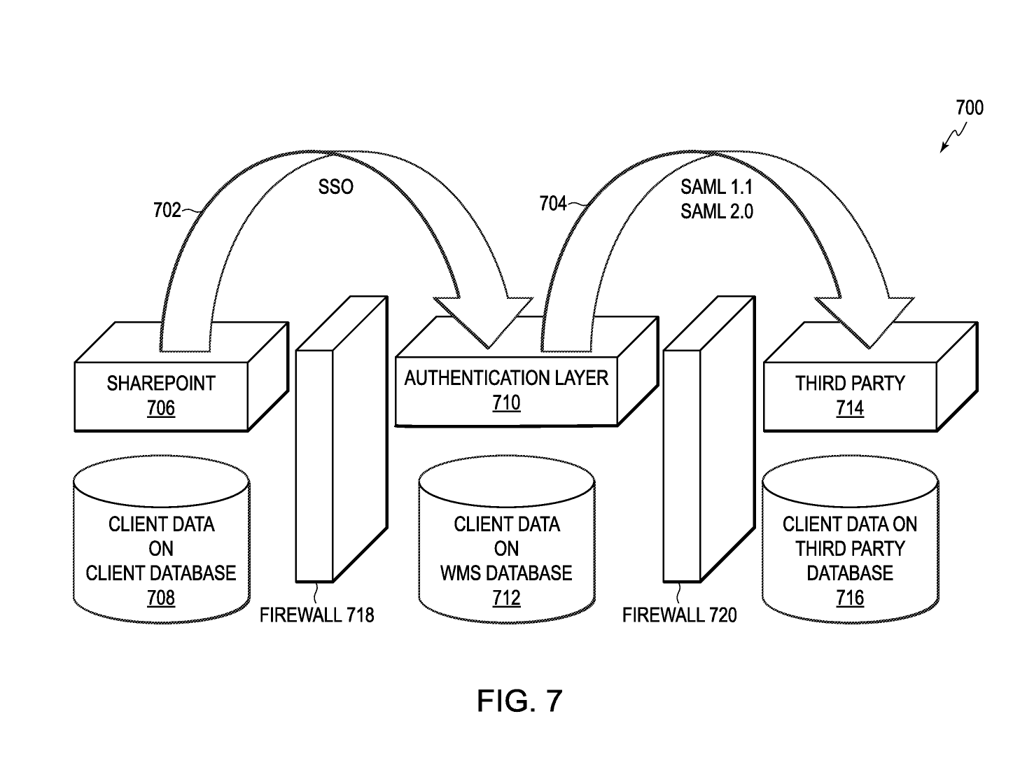

Even running in a SaaS configuration, the system can support enhanced sign-on capabilities. FIG. 7 is a schematic diagram showing an embodiment supporting downstream single sign-on (SSO). In this embodiment, the workflow management system 700 can create downstream SSO 702-704 to other entities (e.g., third-party vendors) using SSO authentication and authorization methods such as SAML. For example, a customer can initiate a request to export data from the customer's database 708 to the database 712 of the workflow management system 700, process the data, and send response data to a third-party site. The request can be initiated through a client portal such as a Sharepoint Portal 706. When the customer is authenticated by the authentication layer 710 through an SSO API, the authentication scheme can retain the authentication and authorization credentials to associate the credentials with the prepared response data and send the response data that can be generated after processing the request data—to the third-party site 714, for example, for storage in a third-party database 716, for the duration of a session.

In the embodiment, request and response data can be sent over firewalls 718-720 in a secure method, for example, using HTTPS POST. Furthermore, the data can be tamper-proofed and time-stamped to further harden the security of the data. The embodiment can also support deep linking navigation in which remote servers that do not support or recognize the associated credentials can still be authenticated even if they use a different authentication scheme. Thus, minimal reconfiguration of remote or third-party systems is required.

The embodiment can also support coordinated sign off, which includes the coordinated destruction or expiration of multiple sessions. For example, upon receiving authenticated instructions or automated internal triggers to do so, the authentication layer can destroy, expire, or otherwise invalidate previously-valid sessionized tokens.

The embodiment can also support coordinate session management, which includes managing multiple sessions or sessionized tokens. The authentication layer can provide an API that allows customers to manage their own or downstream SSO sessions.

The embodiment can re-authenticate automatically when needed. For example, when the authentication layer detects that a session is expired or will soon expire within a predetermined amount of time, the authentication layer can automatically renew the session. Alternatively or additionally, the authentication layer can notify the credential supplier or the expired or impending expiration of the session.

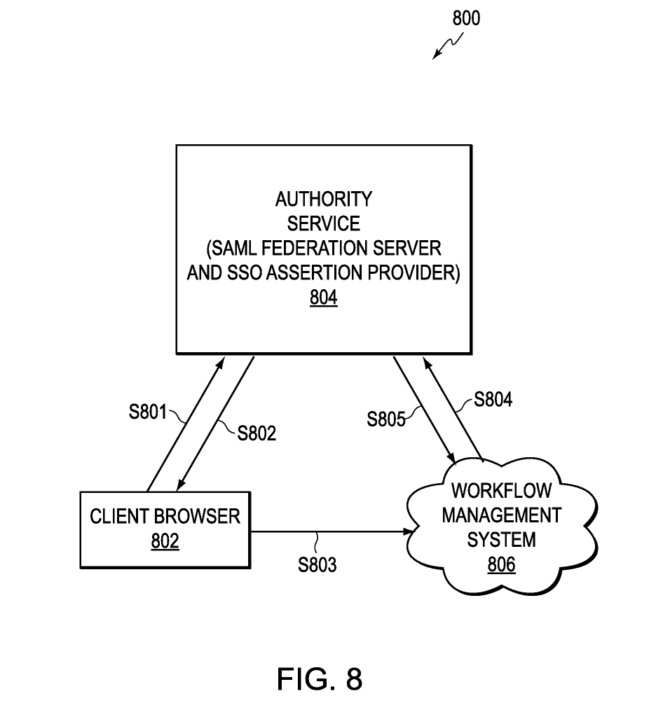

FIG. 8 is a schematic diagram showing an authentication model 800 of an embodiment, where an external authority service 804 is provided at a physically separate location from the workflow management system 806. Under the authentication model, the user, for example, using a client browser 802, can log in to the external authority service 804 through a login page by providing login credentials (S801). The external authority service 804 can be a SAML federation server and SSO assertion provider and can be hosted on the customer's premise (within the customer's firewall), within a cloud cluster to which the workflow management system 806 belongs, or at another site. After authenticating the user by processing the login credentials, the external authority service 804 provides a redirect URL with a security token to the user (S802). The user then uses the redirect URL with the security token to access the workflow management system 806 (S803), where the authentication layer can examine or further process the security token before forwarding the security token to the external authority service 804 for verification (S804). The external authority service 804 then responds to the authentication layer with whether the token is valid (S805).

2. Data Architecture: Workflow Objects and Business Rules

The workflow object class and business logics of embodiments will now be described with reference to the following figures. Used herein, the term “object” can refer to a class, instances of the class, or both, for example, in the context of object-oriented programming. Used herein, the term “step” can refer to a data representation of any task, subtask, or group of tasks that constitutes part of a workflow. A step can even include an entire workflow or just trigger or cancel another workflow.

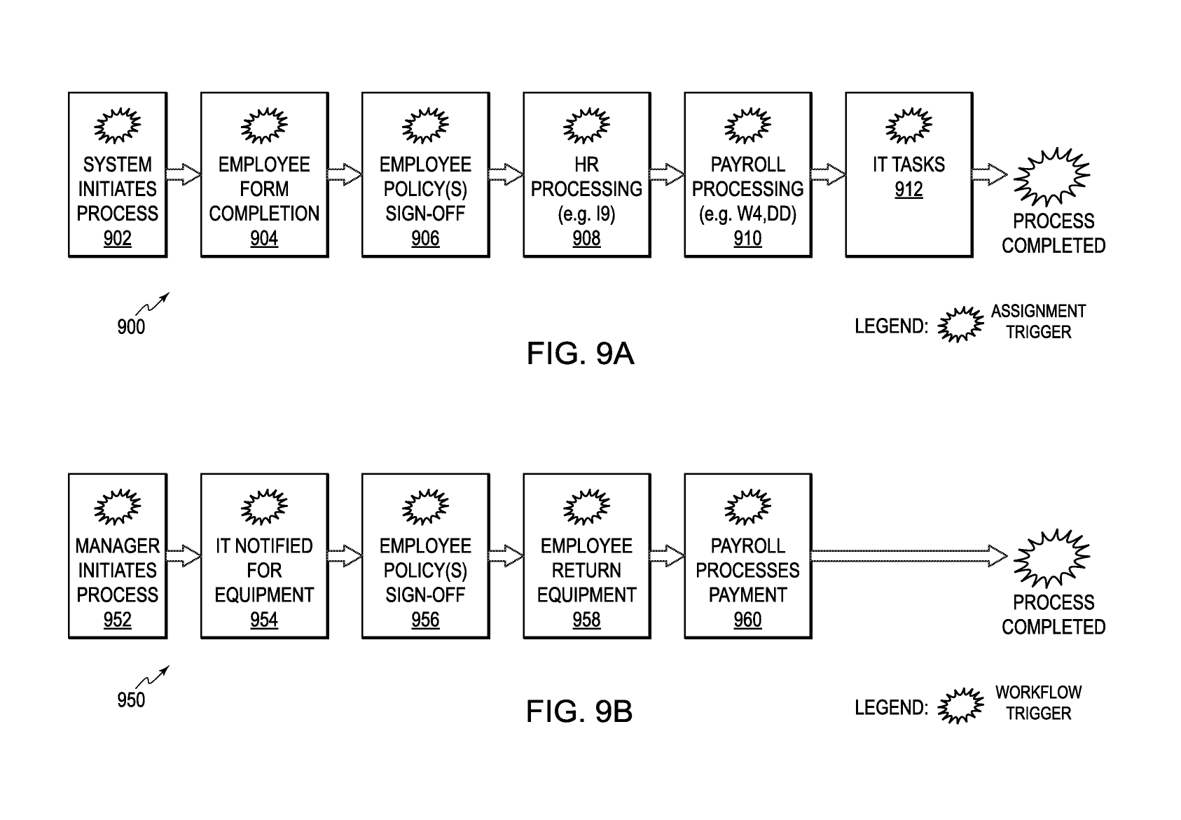

FIG. 9A is a flow diagram illustrating a simple linear business workflow such as a new-hire onboarding workflow 900 showing each operating task when a new employee is hired in an organization. The workflow 900 includes a plurality of tasks 902-912 and is serial in that the workflow 900 might have to be sequentially executed, for example, because the execution of a task depends on data resulting from the completion of a preceding task. Each of the tasks can have subtasks (which can also be considered to be tasks) and be assigned to different entities. Each task is prefixed with the assignee of the task the system is assigned to the task 902 of initiating the workflow, the employee is assigned to the two tasks 904-906 of form completion and policy sign-off, the Human Resources Department (HR) is assigned to the task 908 of processing paperwork completed by the employee, the Payroll Department is assigned to the task 910 of further processing payroll paperwork that is dependent on the employee's paperwork and HR's processed paperwork, and the Information Technology Department (IT) is assigned tasks 912 once payroll has completed the tasks. The workflow 900 can include assignment triggers at various tasks—the assignee for any task may need to be changed from the previous task. For example, no new assignment needs to be made when the employee completes forms 904, because the employee must still sign off on the company's policies 906. Thus, although form completion 904 and policy(s) sign-off 906 are logically discrete tasks, they are assigned to the same entity. A new assignment needs to be made when the employee has signed off on the company policies 906, because HR is then responsible for processing the employee's form paperwork 908.

FIG. 9B is a flow diagram of a simple linear business workflow such as a voluntary termination workflow 950 showing each operating task when an employee voluntarily terminates employment with the organization. The workflow 950 includes a plurality of tasks 952-960. As with the new-hire onboarding workflow 900 of FIG. 9A, the voluntary termination workflow 950 is shown to be serial for simplicity of illustration, but the workflow 950 does not need to be a serial workflow. The workflow 950 can include workflow triggers at various tasks—the active task can trigger another workflow or task in a logically separate workflow. For example, to start the workflow, a manager of the employee is assigned the task 952 of initiating the following tasks 954-960. This triggers an assignment of the workflow 950 to the manager. Then at task 954, IT is notified by an initiating manager that IT should receive equipment from the employee and an assignment is triggered to assign the workflow 950 to IT. At task 954, any number of additional workflows (not shown) can be triggered, including invalidating login credentials, revoking network privileges, closing an email account, and/or preparing for data destruction. Each of those workflows can have their own tasks and subtasks. Then, an assignment is triggered at task 956 to assign the workflow 950 to the employee for signing off on the organization's policies. Then, no assignment is triggered at task 958, because the workflow 950 was already assigned to the employee in the preceding task 956. Then, an assignment is triggered at task 960 to assign the workflow 950 to the Payroll Department for processing any outstanding payments. The workflow 950 proceeds to completion.

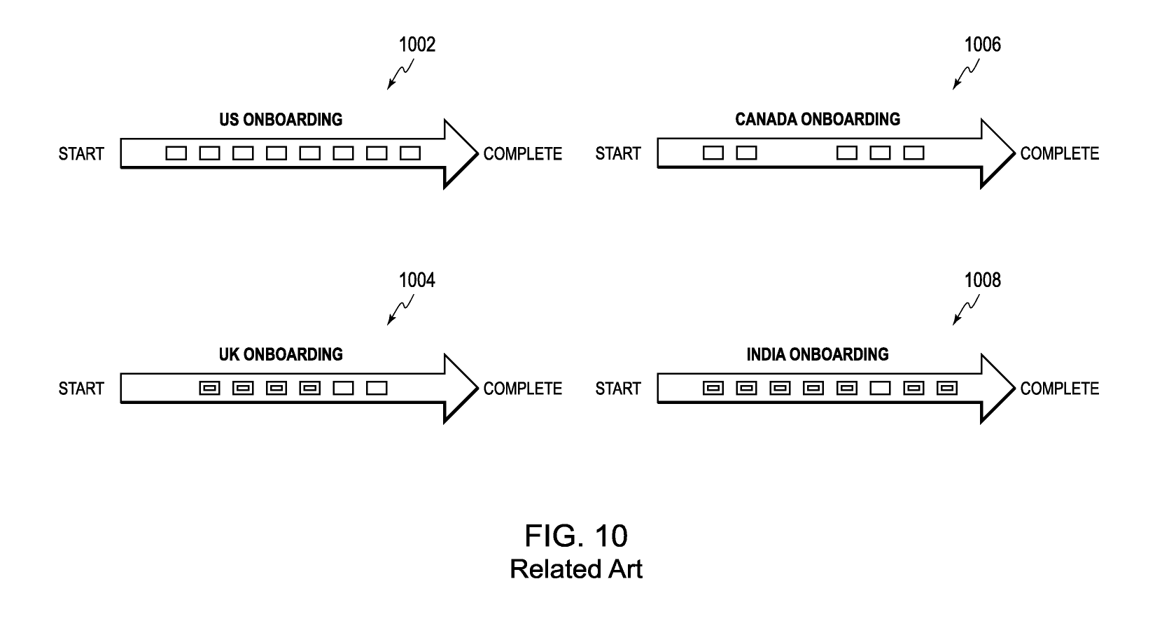

FIG. 10 is flow diagrams illustrating the traditional approach to workflows, where each of a plurality of workflows are created, managed, and maintained separately. For the goal of onboarding a new hire, a global organization with employees in the United States, the United Kingdom, Canada, and India can have four separate workflows 1002-1008 respectively. A sufficiently large organization can have four regional administrative entities that create, manage, and maintain each workflow corresponding to their respective regions. This can result in duplicative work, varying application of company policies, and difficulty for any one person or administrator to oversee the workflows from a global perspective to ensure consistency and efficiency. Thus, the organization can have increased operational expenses to execute the processes, cover material costs, and maintain required headcount. The inability to track the status of a workflow from an overseer's perspective can lead to lack of accountability. The inefficiencies can lead to longer workflow execution times.

Alternately, a large organization might have a single administrative entity that creates, manages, and maintains each workflow separately. Although the monolithic approach can eliminate some of the inefficiencies inherent in having regional administrators, the single administrative entity may still find difficulty to coordinate each process due to a variety of factors including time zone differences, proper file management, and multi-node correspondence. Even if the single administrative entity becomes proficient at handling the regional workflows, the organization may struggle to restore such proficiency when the administrative entity leaves the organization.

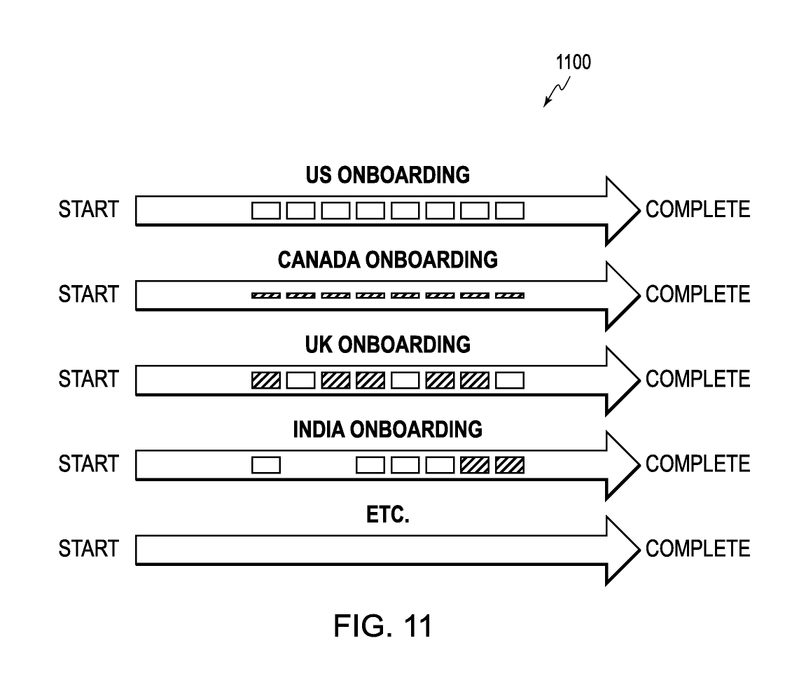

FIG. 11 is a flow diagram illustrating a viewable instance of a single global workflow object that is created, managed, and maintained as a unified workflow according to an embodiment. In particular, the viewable instance of the global workflow object 1100 can have different tasks for each onboarding workflow in each of the aforementioned regions, and the organization using the global workflow object 1100 realizes advantages by providing a single workflow object that any administrative entity(ies) can create, manage, and/or maintain.

For example, just by viewing the tasks of each workflow in the instance, the administrative entity can recognize where work is unnecessarily being duplicated. By tracking and comparing the statuses of the onboarding workflows, the administrative entity can recognize where some tasks or series of tasks are being executed more slowly or quickly in some regions than others. By viewing the results of the tasks, the administrative entity can recognize where company policies are applied inconsistently. By analyzing the instance 1100, the administrative entity can initiate measures to fix and/or improve the workflows in each region. For example, the administrative entity can manage the global workflow object 1100 by eliminating at least one task of similar tasks in one or more regions. Accordingly, the global workflow object 1100 can use a single common task in each of the appropriate regions. Eliminating repetitive tasks can reduce duplicative work and streamline the unified workflow. Additionally, for example, the administrative entity can manage the global workflow object 1100 by consolidating a plurality of tasks into a single task. Consolidating tasks can improve efficiency and improve the overall unified process flow between onboarding workflows. Further exemplary embodiments are discussed below.

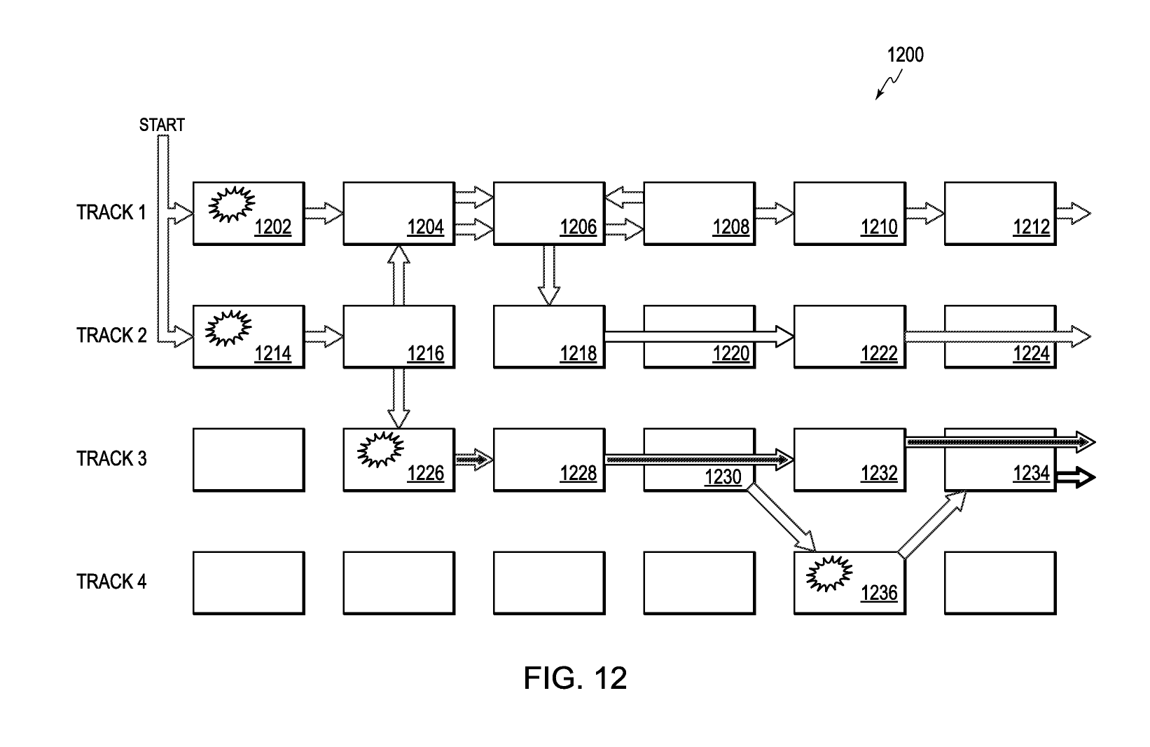

FIG. 12 is a schematic diagram showing an exemplary unified workflow object 1200 of an embodiment. The exemplary unified workflow object 1200 is defined by combining steps of at least two workflows, for example, represented by tracks 1-4. The unified workflow object includes a plurality of steps 1202-1236 that each has an associated track. The tracks can be represented by any data structure (e.g., an object or a struct) that can associate the track with any individual workflow, grouping of step(s), and/or assignable entity information. The association can be in the form of mutable or immutable fields or methods and are created and managed through the workflow management framework.

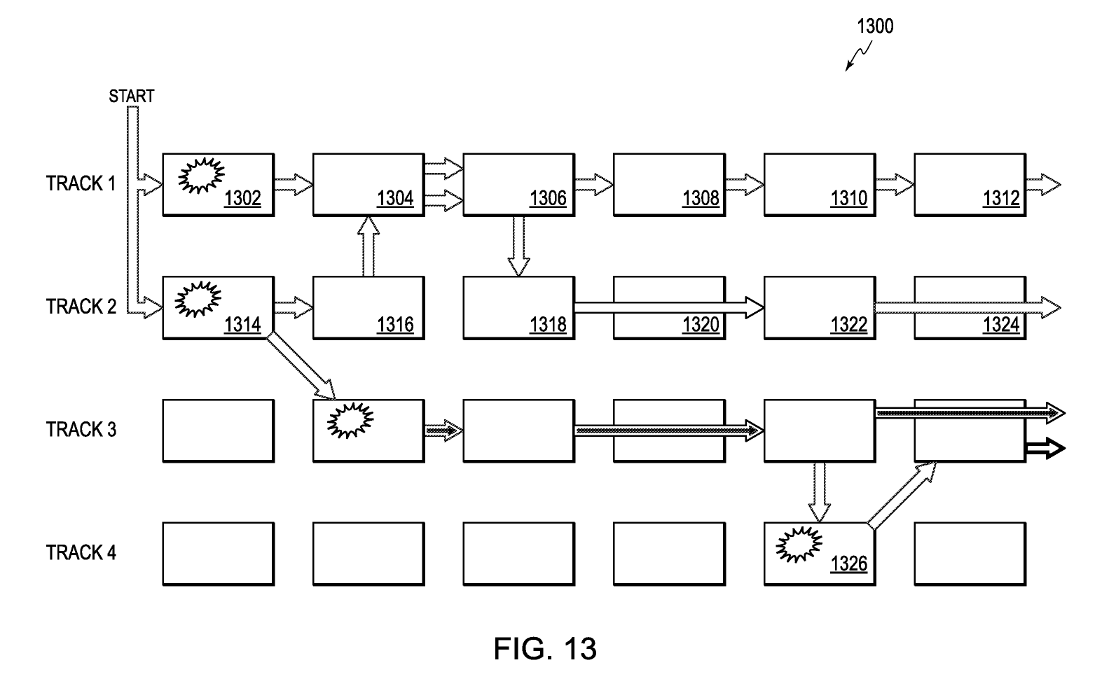

Arrows between the steps (in FIGS. 12-13) can represent any kind of relationship, but they preferably indicate execution dependency. For example, the execution of step 1204 depends on data from steps 1202 and 1216. As described in more detail below, this can mean that the trigger condition of step 1204 depends on the status or termination conditions of steps 1202 and 1216.

Tracks can be defined based on any assignable entity attribute(s). An assignable entity is any person(s), machine(s), a system of machines, department(s), office(s), or other entity(s) that is/are capable of executing a task. The assignable entity can have any number of attributes including entity type (e.g., person, machine, etc.), entity name, unique entity identifier, entity responsibility, entity location, entity language, entity job title, entity department, entity product or service, entity expertise, entity experience, entity salary, etc. Thus, a track can be defined based on the entity job title of “Manager” (an assignable entity attribute) such that all managers are responsible for executing the steps associated with the track. Alternatively, a track can be defined based on any Boolean operators applied to the assignable entity attribute(s). For example, a Boolean operator “entity name is ‘Dave Johnson’ OR entity name is ‘Joe Smith’”, can be used to define a track for Dave Johnson and Joe Smith.

Tracks can be predefined. For example, the unified workflow object 1200 can be defined by combining steps of regional workflows. In this example, the Tracks 1-4 can each represent a new-hire onboarding workflow corresponding to one of a plurality of regional workflows for onboarding a new hire including those in the United States, the United Kingdom, Canada, and India, respectively. In this example, the onboarding workflow in the United States of Track 1 can include steps 1202, 1204, 1206, 1208, 1210, and 1212. The onboarding workflow in Canada of Track 3 can include steps 1226, 1228, 1230, 1232, and 1234.

As another example, the unified workflow object 1200 can be defined by combining steps of assignee workflows. In this example, Tracks 1-4 can each represent a new-hire onboarding workflow corresponding to one of a plurality of assignees including a manager, HR, IT, and the Facilities Department, respectively. In this example, HR's Track 2 can be considered a workflow with steps 1214, 1216, 1218, 1220, 1222, and 1224. The Facilities Department's Track 4 can be considered a workflow with only one step 1236. Predefined tracks are created and managed through the workflow management framework.

Tracks can be defined dynamically with either user input, built-in intelligence, or a combination thereof. For example, a building construction job that requires a specific set of subcontractors who have guaranteed their availability can include a multiplicity of workflows. The client might have specific needs, for example, that the subcontractor that installs the plumbing be able to supply and install PEX piping. The system can search a database of known subcontractors with experience in PEX piping who have made bids on the job and present a list of known subcontractors who fit the criteria for user selection, tentatively assign the plumbing track to the most preferred subcontractor (ranked in any manner selected by the client, for example, by price or by work history or any combination of those or similar factors) subject to user approval, or assign the plumbing track to the most preferred subcontractor automatically. The predefined criteria and selection algorithm(s) are stored as business rules, which are managed by the business rules engine.

Tracks can be multi-dimensional. For example, regional workflows and assignee workflows can be combined so that there are 16 tracks (for each of a manager, FIR, IT, and the Facilities Department in each of the United States, the United Kingdom, Canada, and India). Any other number of selectable criteria associated with an assignable entity can be used to define or to further define a track. For example, a track can be created for engineers (entity job title) in India (entity location) working on a product named “Orchestration Engine” (entity product) with expertise in Java programming (entity expertise).

Tracks can be associated with the system itself thus allowing the associated steps of the track to be executed by the system. For example, a system track can include steps that cause it to commit information to a database for later consumption by a third-party system after certain steps (such as submitting the contents of a form) are complete.

Steps can be represented by any data structure that can associate the step with, for example, a real-world task, with one or more tracks, with one or more trigger conditions, with one or more termination conditions, with one or more due dates, with one or more at-risk dates, with one or more approvers, with one or more notification targets, with one or more form documents and resources, and/or with one or more unified workflow objects. The data structure can further associate the step with an assignment trigger, for example, as a sub-function or -field of the trigger condition. These associations can be in the form of mutable or immutable fields or methods and are managed through the workflow management framework. Steps can further have a status field that has any of a number of statuses such as INACTIVE, ACTIVE, ON HOLD, COMPLETE, PENDING STEP X, etc.

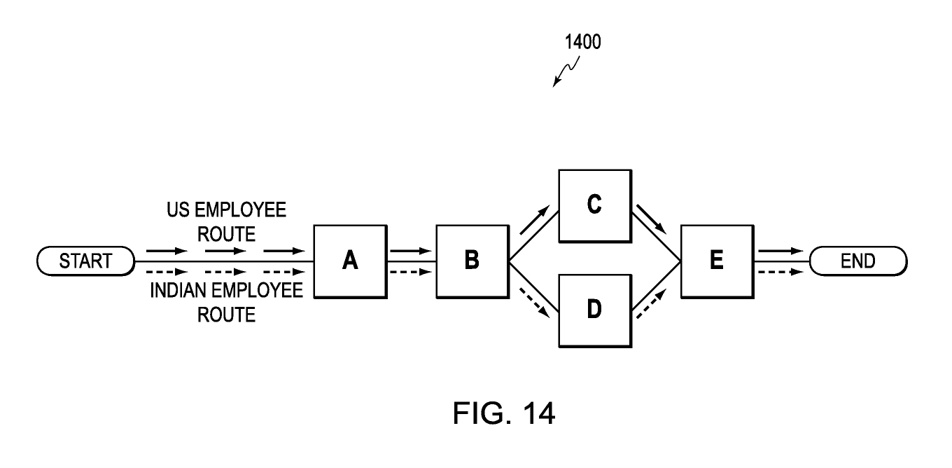

Steps can be associated with tracks in a variety of ways. A mapping from steps to tracks can be surjective, injective, or bijective. FIG. 13 is a schematic diagram showing an exemplary unified workflow object 1300 with steps 1316-1324 that are associated with more than one track: Tracks 2 and 3. In this unified workflow object 1300, step 1316 is triggered and assigned to both Track 2 and 3, but can be dependent on the completion of step 1314. FIG. 14 is a schematic diagram showing an exemplary workflow 1400 with two tracks and shared steps. In the figure, a first track corresponding to a U.S. employee includes steps A, B, C, and E, and a second track corresponding to an Indian employee includes steps A, B, D, and E. Steps execute sequentially in a left-to-right order starting at “start” and ending at “end”. Steps A, B, and E are shared by both tracks.

The exemplary parent-child relationship table below corresponding to FIG. 14 enables the system to process the steps in the correct order. For example, the system can process step A before processing step B because A is a parent of B.

| Parent | Child (execution depends on Parent) |
|---|---|
| --start-- | A |
| A | B |
| B | C |
| B | D |
| C | E |
| D | E |
| E | --end-- |

Steps can be associated with tracks in a predefined manner, for example, a step of creating a company email account is always assigned to IT. Predefined associations can be created and maintained through the workflow management framework.

Steps can be associated with tracks dynamically (e.g., based on conditions and/or parameters that change during execution of a workflow).

For example, steps can be associated with tracks based on termination conditions or other data of other steps—a step of processing 401K paperwork can be assigned to different HR representatives based on whether the employee is exempt or non-exempt.

As another example, steps can be associated with tracks based on any number of time conditions—a new hire that took longer than two weeks to fill out health care information can cause a step for processing health care paperwork to be assigned to a more experienced HR representative who can process the paperwork faster to meet an impending deadline, or a new hire hired in colder months can cause a step for rolling out work equipment to be assigned to a winter outfitting crew rather than a warm-weather outfitting crew.

As another example, steps can be associated with tracks based on features of the tracks themselves—a track associated with the new hire's manager may have every step co-assigned to the track. Association algorithms can include any of the foregoing conditions or others and are processed by the business rules engine.

As another example, steps can be associated with tracks based on user input. For example, during execution of a workflow, the presentation layer can present to the assignee of a given step a selection dialog that allows the assignee or approver of the given step to assign the next step in the track.

The trigger condition of a step can vary. A trigger can be conditioned on any one or more of the following conditions.

A trigger can be conditioned based on assignment. The first step of each track can have assignment triggers (indicated by explosion graphics in FIGS. 9, 12, and 13). Assignment triggers can be based on any condition corresponding to business logic. For example, receipt of a signed employment contract or offer letter can trigger the onboarding process for a new hire, indicated by “START”. Thus, the entities corresponding to Tracks 1 and 2 (e.g., regional branch offices or assignees) in FIG. 12 are assigned steps 1202 and 1214 respectively.

A trigger can be conditioned on the termination of another step or steps. For example, step 1204 can be configured to trigger when step 1202 is complete, step 1216 is complete, or both steps 1202 and 1216 are complete—this dependency is indicated by arrows. A trigger can be condition based on termination conditions of downstream steps as well. For example, the termination of step 1208 can cause step 1206 to be retriggered or the workflow can proceed to step 1210.

A trigger can be conditioned on time. For example, certain steps can be configured to trigger after a predetermined amount of time has passed since another step is triggered or teiminates. The amount of time can vary based on a number of factors. For example, an onboarding workflow for an executive might allow a shorter timeframe for completion than for an individual contributor. As steps in the executive onboarding workflow are completed, certain steps can have shorter trigger durations in view of an impending deadline for completion.

The termination condition of a step can vary. Used herein, “termination” includes any act that causes an associated step to change to an inactive or complete status, change from an active status, or dissociate from the associated track and/or workflow object. Termination can be conditioned on any one or more of the following conditions.

Termination can be conditioned on completion of an electronic form provided by the system. For example, in a step of completing direct deposit paperwork, a direct deposit form can be associated with the step and displayed to the new hire through the presentation layer. The step can be automatically terminated when the electronic direct deposit form with all relevant information has been completely filled out by a new hire. Alternatively, the step can await approval by another entity to which the step (or sub-step) is co-assigned before the step is terminated as complete.

Termination can be conditioned on time. For example, a step that becomes obsolete due to passage of time can terminate. As another example, a step that reaches a timeout (for example, set by a system administrator) can automatically terminate.

Termination can be conditioned on other direct user input. For example, for a step that is not based on data manipulation (e.g., paper-based or electronic), such as moving a computer to a work area, the assigned entity of the step (i.e., the entity associated with the track to which the step is associated) can mark the step as complete. The workflow object can have sign-off verification so that another entity (e.g., manager or coworker) must also mark the step as complete before the system will recognize that the step's status is complete.

Termination can be conditioned on the status or status change of another step. For example, when another step changes to a status where it is pending the status of the current step, the system may put the current step on hold to avoid a deadlock situation.

Termination can be conditioned on track data. For example, termination can be based on assignable entity information corresponding to a track. If the assignable entity information of a track meets certain conditions, matches certain criteria, and/or changes, then the step can terminate.

A due date of a step can set off one or more alerts to interested parties. The due date can be based on a predefined date, a predefined timeframe relative to the initiation of the workflow or any step within the workflow, and/or a dynamically defined date that changes based on various factors during execution of the workflow, for example, rate of completion of other steps. A dynamic definition can also be based on internal intelligence. For example, the system can learn that through many executions of a certain step, a particular employee from the HR department always takes 25% more time to complete the step—accordingly, the system can accelerate or decelerate related steps (e.g., a step dependent on the certain step) based on the learned information.

An at-risk date of a step can also set off one or more alerts to interested parties. The at-risk date can be related to the due date and can also be calculated based on predefined timeframe information—for example, an administrator of the relevant workflow that contains the step can customize the at-risk date of a step to be one week before the due date. The at-risk date can also be calculated based on dynamic timeframe information based on internal intelligence as discussed above with respect to the due date.

An approver of a step can be an entity who must verify completion and/or contents of a step. For example, the approver can be the assigned entity's direct supervisor.

A notification target can be an entity who can receive notifications related to execution of the step.

A form document can be any document containing fields related to information pertinent to completion of a step. For example, a direct deposit form can be a form document related to a step of completing the direct deposit form. The direct deposit form can have multiple fillable fields (e.g., name, bank account information, employee ID, etc.), and the system can allows an administrator to set read and write permissions on the contents of each field. For example, an employee can view and edit all fields, HR can view all fields, and a manager can view the name and employee ID fields.

A resource can be a URI, URL, link, document, picture, video, or any other data that can be used to inform the completion of a step. For example, a product manual for laptop computer can be a resource for a step of deploying a laptop computer to a new employee.

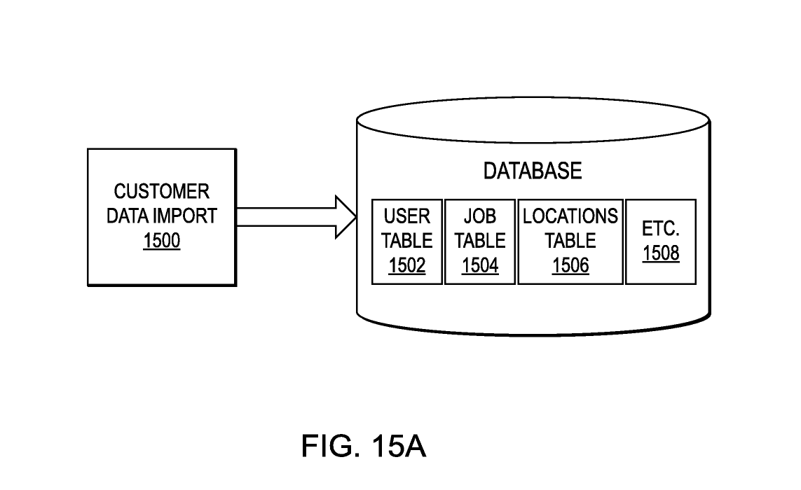

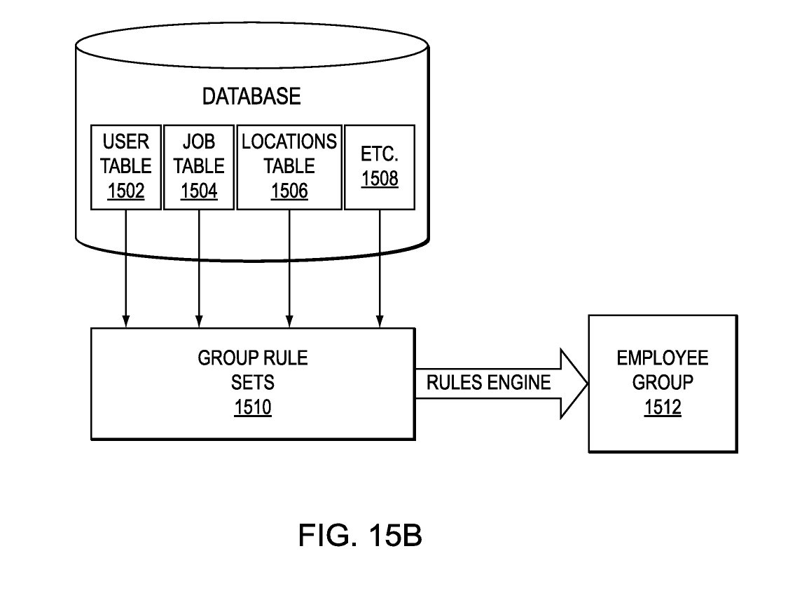

Associations, conditions, and attributes can be saved as rules to be processed by the business rules engine. FIG. 15A is a flow diagram illustrating a data import 1500 that populates assignable entity attributes into the database, for example, assignable entities (e.g., users of the system) to a user table 1502, their associated jobs in a jobs table 1504, their associated locations in a locations table 1506, and other information 1508 regarding the assignable entities. The workflow management framework can convert the imported information into a uniform format that is readable by the system prior to insertion into the database. Any known tool, such as MAP-FORCE by Altova, can be used to import and convert data into a uniform format.

FIG. 15B is a flow diagram illustrating group rule sets applied by the business rules engine of an embodiment. Group rule sets 1510 are sets of rules applied to one or more users having one or more assignable entity attributes in common (an employee group 1512). The rules are associated with the employee group 1512. The employee group 1512 can be the basis for one or more tracks. The business logic layer creates and allows for the creation of group rule sets 1510 based on the imported data by, for example, querying or analyzing the information 1502-1508 stored in the database. For example, a group rule for individual contributors can require every step related to payroll be signed off by the individual contributor's director. As another example, a group rule for engineers working at a high security location can require that every onboarding process requires an additional step of taking an orientation course in trade secrets. As another example, a group rule for engineers working at a high security location can require that the engineers are given security access cards. Thus, the group rule set 1510 for individual contributors includes the first rule, and the group rule set for engineers working at a high security location includes the second and third rule.

Group rule sets 1510 can be managed by the system to enhance management efficiency. For example, a group rule set that is associated with an employee group of engineers in a high security location can be quickly associated with an employee group of engineers in a new high security location, because the group rule set is already defined and can thus be re-associated or duplicated within minimal modifications to stored data. As another example, an administrator can quickly retrieve all of the group rules associated with an employee group and also quickly edit, add, or delete rules for all members of the employee group in batch rather than individually. Further, group rule sets for an employee group can be used as a template for another employee group.

Group rule sets 1510 can enhance the context sensitivity of the system to provide additional intelligence for the business rules engine. For example, when a workflow is requested to be initiated, the system can recognize the employee groups of the requestor and construct a workflow with the appropriate steps based on the group rule sets for those groups. As another example, by analyzing multiple group rule sets 1510 corresponding to all employee groups of which the requestor is a member, the business rules engine can determine if there are conflicts or duplicative steps that do not need to be executed for the requestor. As another example, the business rules engine can construct or propose workflows including customizing workflow parameters based on assignable entity attributes of the employee, such as the employee groups 1512 and group rule sets 1510.

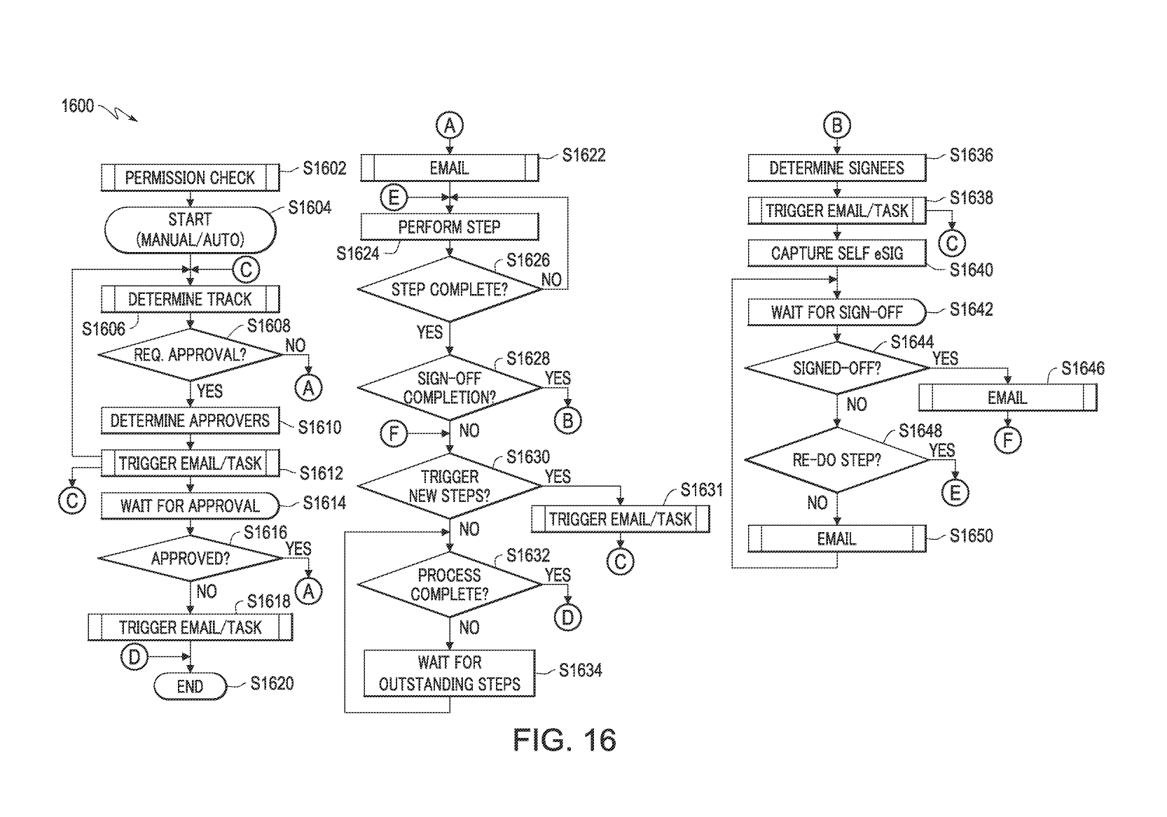

FIG. 16 is a flow diagram illustrating an exemplary workflow execution algorithm 1600 based on a workflow object of an embodiment. At S1602, the system has received a request to start the workflow execution algorithm 1600 and the authentication layer verifies that a requestor has the proper permissions to initiate the workflow execution algorithm 1600. The start request can also be started automatically by the system. At S1604, the system starts the algorithm. At S1606, the system determines the track of a first step.

When the track is determined, the system at S1608 determines whether the assignment of the first step to the associated track(s) requires approval. If the assignment requires approval, then the system determines the approver(s) at S1610. At S1612, a second step is triggered and the system determines a track (e.g., approver for the first step) for the second step at S1606 and the algorithm continues similar to before. Optionally, a notification such as an email can be sent at S1612 to the approver to request approval. The system waits for approval of the assignment of the first step at S1614.

If the approver fails to approve at S1616 the assignment of the first step, a third step is triggered and assigned back to the requestor (who is optionally notified) at S1618 and the algorithm ends at S1620. The third step can be a notification or have any number of subtasks, for example, displaying the whole or partial audit trail of the workflow to the requestor to better inform the requestor and allow the requestor to remedy the situation.

If either approval is not required at S1608, or approval is required at S1608 and the assignment of the first step is approved at S1616, then the trigger condition for step 1 is met, an optional email is sent at S1622.

Once the first step is performed at S1624, the system determines whether the step is complete at S1626. If the first step is not complete (or the termination condition is otherwise not met), then the system returns to await performance of the step by the assignee at S1624. If the step is complete at S1626, then the system determines whether the completion requires sign-off verification at S1628. If the completion does not require sign-off verification at S1628, then the system determines at S1630 whether to trigger a new step based on the completion of the first step. If the new step should be triggered, then the system triggers the step at S1631 and returns to S1606 to determine the track of the new step.

If no new step should be triggered at S1630, the system determines whether the workflow is complete at S1632. If the workflow is not complete, for example, steps are still outstanding, then the system awaits termination of the outstanding steps at S1634 and can optionally repeat to determine whether the workflow is complete at S1632. If the workflow is complete, then the system ends the workflow at S1620.

If at S1628, the completion of the first step requires sign-off verification, the system determines the signees at S1636 and triggers a fourth step at S1638 for procuring signature approval. The system returns to S1606 for signature approval, captures the signature approval of the assignee of the first step at S1640, and waits for sign-off at S1642. When the signees all sign off at S1644 (which corresponds to S1626 of the fourth step), then an optional email is sent at S1646 and the system determines whether to trigger a new step at S1630.

If the signees have not signed off at S1644, then the system determines whether to redo the first step at S1648. If not, then the system optionally sends a notification to the assignee at S1650 and continues to wait for the sign-off at S1642. If the system determines that the first step needs to be redone, then the system returns to S1624 and awaits the step to be performed.

During execution of the algorithm, the conditions that caused each step to trigger, the conditions that caused each step to terminate, the assignee, and other information can be logged into a database for later auditing.

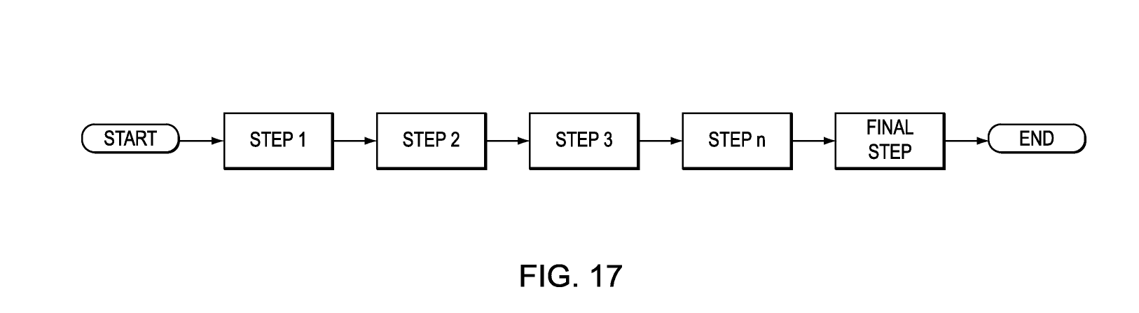

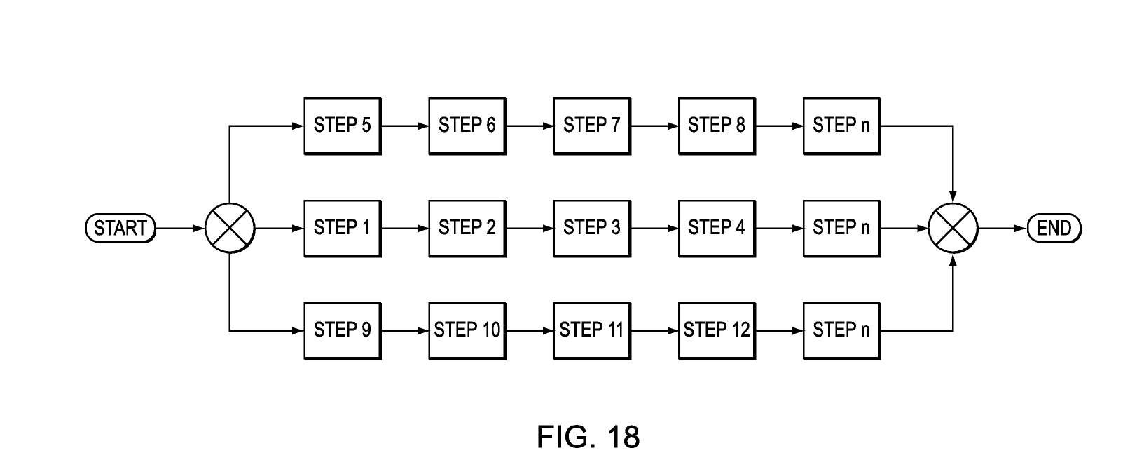

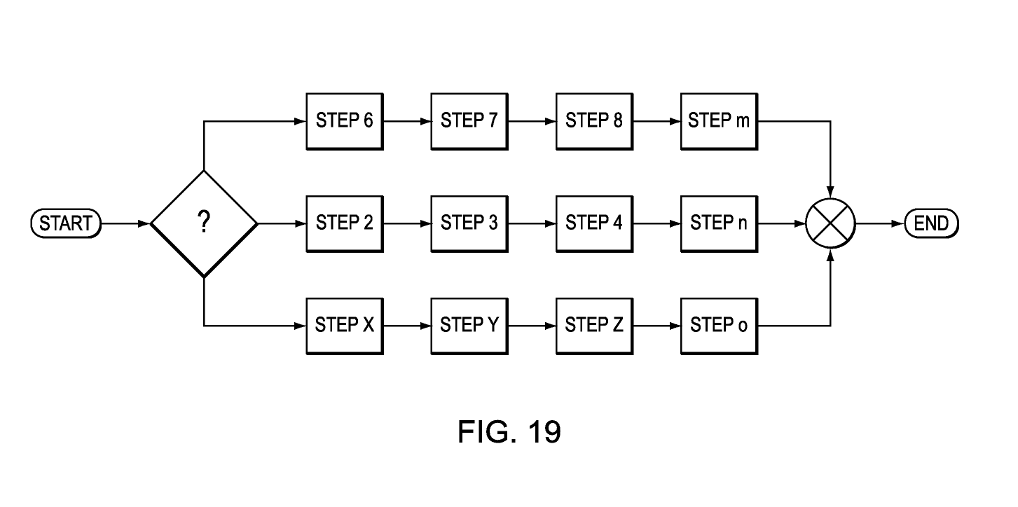

Because of the above-mentioned versatilities of the unified workflow object, any number or types of workflows with any number of steps and/or tracks can be automated. For example, the unified workflow can be linear as shown in FIG. 17. As another example, the unified workflow can have multiple tracks executing in parallel as shown in FIG. 18. In FIG. 18, steps 5-8 are associated with a first track, steps 1-4 are associated with a second track, and steps 9-12 are associated with a third track. The tracks can each correspond to a mutually independent workflow or the tracks can correspond to workflows with steps that have cross-dependencies. For example, all three tracks can share a Step n. As another example, the unified workflow can have multiple tracks where the tracks selected to be executed are based on a decision as indicated by a diamond-shaped decision box in FIG. 19. in FIG. 19, a business decision is made at the diamond-shaped decision box to determine whether to execute any one or more of the three displayed tracks.

3. Presentation Layer

Data can be displayed intelligently in a user interface corresponding to what is relevant and/or important to a user and taking special advantage of features of the embodiments.

Because the track definitions are stored in the system, the presentation layer can display selectable criteria for the user to select to generate a displayed view of the unified workflow object (or any portion of therein) based on the selected criteria. For example, the presentation layer can display options to sort the information by various dimensions of criteria including the assignable entity attributes that define a track in a workflow. The presentation layer can further display the active workflows of the user including the status and current active steps of the workflow.

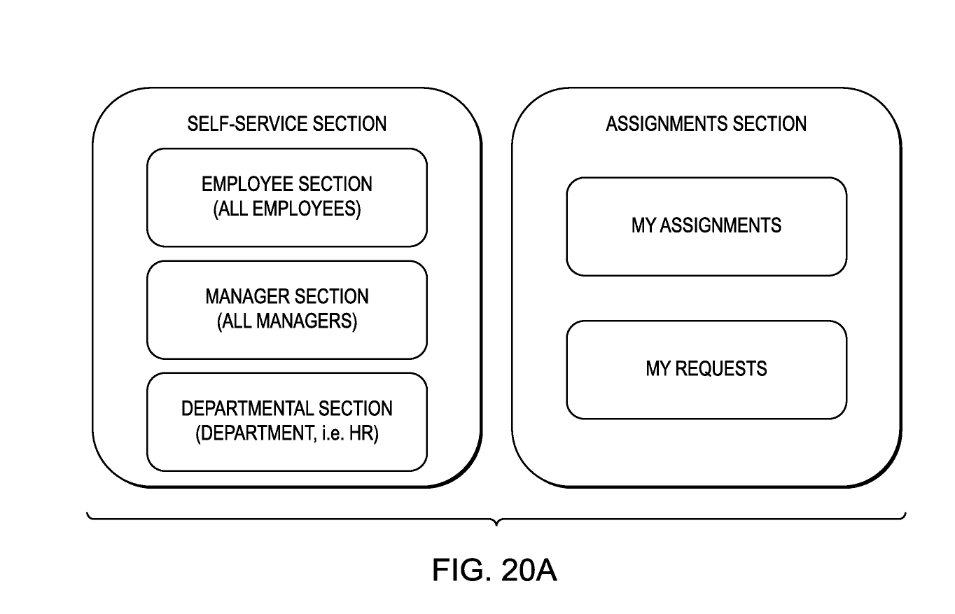

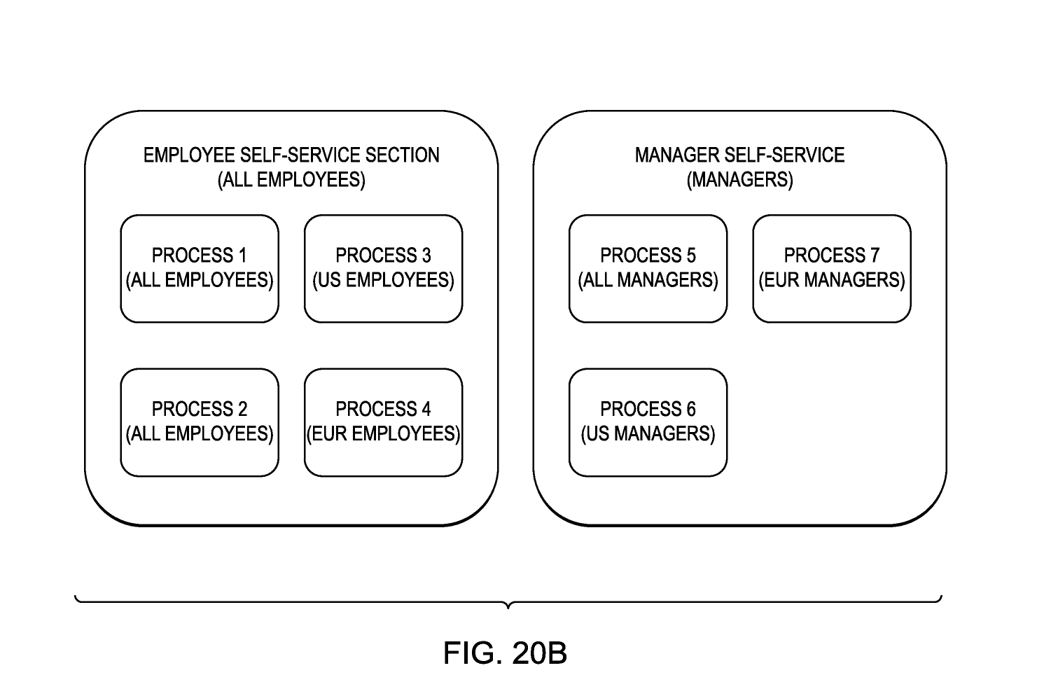

FIG. 20A is a UI diagram showing an exemplary context-sensitive workflow initiator interface of an embodiment. Because the employee groups are stored in the system, the presentation layer can provide a context-sensitive workflow initiator interface that allows a particular user to view all of the workflows that the user can initiate. For example, an HR director that oversees HR operations in the United States and in Europe might have a self-service section that allows the director to access all sections corresponding to groups of which the director is a member (e.g., employee, manager, and HR sections). FIG. 20B is an exemplary UI diagram showing in further detail the workflows that the director can initiate based on the director's employee groups and/or assignable entity attributes in the exemplary context-sensitive workflow initiator interface. In the Employee Self-service section, workflows 1-2 are available to the director because the director is an employee, workflow 3 is available to the director because the director is a U.S. employee, and workflow 4 is available to the director because the director is also a European employee. In the Manage Self-service section, workflow 5 is available to the director because the director is a manager, workflow 6 is available to the director because the director is a U.S. manager, and workflow 7 is available to the director because the director is a European manager.

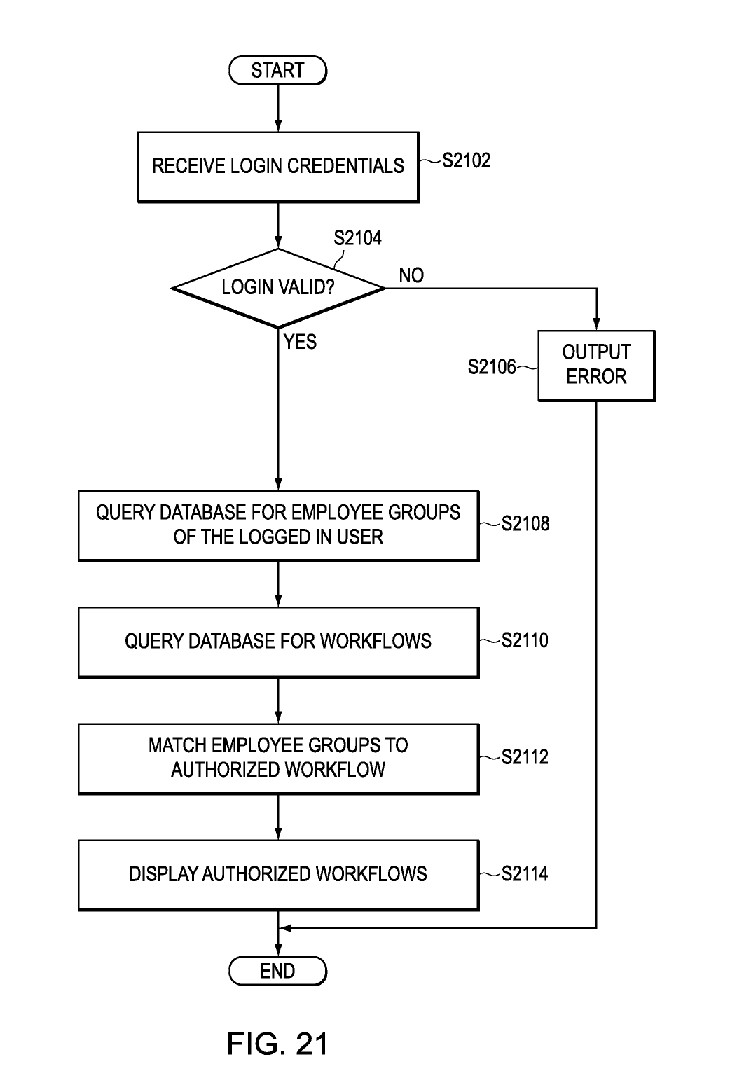

FIG. 21 is a flow diagram illustrating an exemplary method for determining and displaying a context-sensitive workflow initiator interface of an embodiment. The method starts by receiving login credentials at S2102. The authentication layer determines whether the login is valid at S2104. If not, the presentation layer outputs an error at S2106. If the login is valid, the system queries the database for the employee groups of which the logged in user is a member at S2108. The system then queries the database for workflows at S2110. The system then matches the employee groups to the workflows that those employee groups are authorized to initiate at S2112. The presentation layer formats and displays the authorization workflows at S2114.

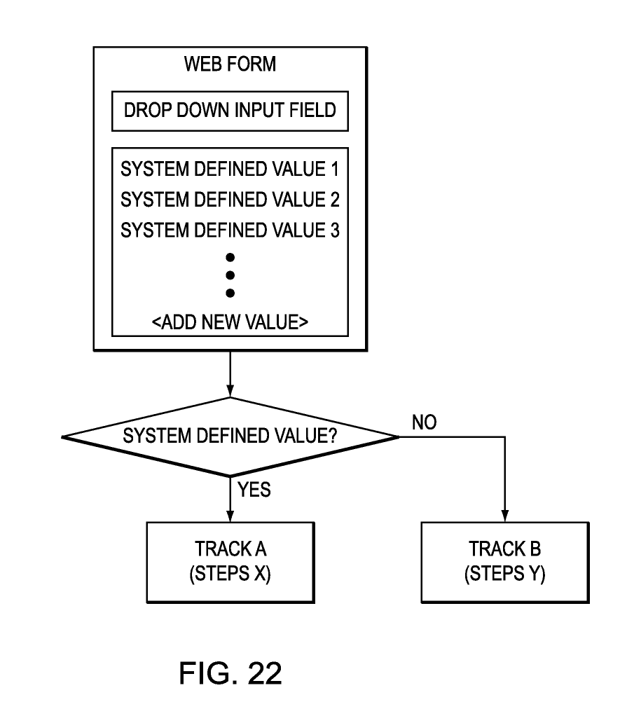

In alternate embodiments as illustrated in FIG. 22, the presentation layer can present a selection dialog or text field that allows the user to either select a defined tag, create a custom undefined tag, and/or input text to associate with a new workflow request. The system can then parse the user's selection, custom tag, and/or input to either trigger a workflow or request additional input from a user who is authorized to assign workflows. For example, the system can use a natural language parsing to parse keywords from the tag and/or input and match those keywords to known keywords associated with particular employee groups or employees. As another example, if a custom undefined tag or input text is received, the system can apply the decision unified workflow as illustrated in FIG. 22 in conjunction with the decision unified workflow illustrated in FIG. 19. The system can determine based on conditions discussed above, or other alternate conditions, to select any one or more of a plurality of tracks to arrange and execute the processes based on the custom undefined text or the input text.

In alternate embodiments, steps S2108 and S2110 can be executed in parallel. In other alternate embodiments, steps S2108, S2110, and S2112 can all be incorporated into a single JOIN statement on the database.

The embodiments of the process management system as set forth above are intended to be illustrative and not limiting. Various changes may be made without departing from the spirit and scope of the invention.

What is claimed is:

1. A computer-readable medium storing instructions for managing workflows, which when executed by a processor, causes a computer to function as:
a business logic layer including:
a workflow creator configured to define a unified workflow by combining steps of at least two workflows, the unified workflow having associated workflow data including (i) step data associated with each of the steps, the step data including track data that associates each of the steps with a track, and (ii) a business rule,
a business rules engine configured to select and apply the business rule to the workflow data, and
a workflow manager configured to manage the unified workflow based on the selected and applied business rule; and
a presentation layer configured to output information regarding the managed unified workflow to a display medium.

2. The computer-readable medium of claim 1, wherein
the workflow data is imported from a non-uniform data format and converted to a uniform data format.

3. The computer-readable medium of claim 1, causing the computer to further function as:
a request-response handler configured to (i) accept a request from an external system, the request containing encrypted request data, (ii) forward the request to the business logic layer, (iii) receive a response from the business logic layer, the response containing encrypted response data, and (iv) return the response to the external system.

4. The computer-readable medium of claim 3, causing the computer to further function as:
a data storage layer configured to store the workflow data, wherein
the data storage layer and business logic layer are configured not to store a decrypted copy of the encrypted request data or the encrypted response data.

5. The computer-readable medium of claim 1, wherein
the step data for a step includes (i) a trigger condition which, when met, causes the associated step to be triggered, and (ii) a termination condition which, when met, causes the associated step to be terminated.

6. The computer-readable medium of claim 5, wherein
the business rules engine is configured to select and apply a business rule to the step data to change the trigger condition or the termination condition based on the track data.

7. The computer-readable medium of claim 5, wherein
the business rules engine is configured to select and apply a business rule to the step data to change the trigger condition or the termination condition based on the step data or step data of another step.

8. The computer-readable medium of claim 5, wherein
the business rules engine is configured to select and apply a business rule to the step data to change the trigger condition or the termination condition based on a timing of at least one of when the unified workflow is initiated, when another step triggers, and when the another step terminates.

9. The computer-readable medium of claim 1, causing the computer to further function as:
a group rule set manager configured to manage a plurality of sets of group rules, each set being associated with at least one of a plurality of assignable entities.

10. The computer-readable medium of claim 9, wherein
the at least one of the plurality of assignable entities is defined based on a shared attribute of the assignable entities.

11. The computer-readable medium of claim 9, wherein
the presentation layer is configured to output information regarding the managed unified workflow that is related to a workflow requesting user upon request.

12. The computer-readable medium of claim 1, wherein
the presentation layer is further configured to output a selection dialog that allows a requesting user to either select a defined tag or create an undefined tag to associate with a workflow request.

13. The computer-readable medium of claim 1, wherein
the presentation layer is further configured to output an interface that allows an initiating user to view and initiate a plurality of workflows that the initiating user is authorized to initiate based on an employee group of which the initiating user is a member.

14. The computer-readable medium of claim 1, wherein
the business logic layer associates or reassociates a step with a track based on a selection of the track by an assignee or approver of another step.

15. The computer-readable medium of claim 1, wherein
the track data associates each of the steps with at least one of a plurality of tracks, and
each of the plurality of tracks correspond to one of a plurality of assignable entities responsible for performing the step(s) in the track.

16. The computer-readable medium of claim 15, wherein
the plurality of assignable entities each having a plurality of members, the members having a common entity attribute, and
the common entity attribute of each track is different from the common entity attribute of other tracks.

17. The computer-readable medium of claim 15, wherein the plurality of assignable entities are entities that are capable of executing a step and are selected from a group consisting of a person, a machine, a system of machines, a department and an office.

18. A workflow management system comprising:
a business logic layer including:
a workflow creator configured to define a unified workflow by combining steps of at least two workflows, the unified workflow having associated workflow data including (i) step data associated with each of the steps, the step data including track data that associates each of the steps with a track, and (ii) a business rule,
a business rules engine configured to select and apply the business rule to the workflow data, and
a workflow manager configured to manage the unified workflow based on the selected and applied business rule; and
a presentation layer configured to output information regarding the managed unified workflow to a display medium.

19. A method of managing workflows, the method comprising:
combining steps of at least two workflows to create a unified workflow, the unified workflow having associated workflow data including (i) step data associated with each of the steps, the step data including track data that associates each of the steps with a track, and (ii) a business rule,
selecting and applying the business rule to the workflow data;
managing the unified workflow based on the selected and applied business rule; and
outputting information regarding the managed unified workflow to a display medium.

20. A computer-readable medium storing instructions for managing workflows, which when executed by a processor, causes a computer to function as:
a workflow creator configured to define a unified workflow for performing a task by combining steps of at least two workflows for performing the task, the unified workflow having associated workflow data including step data associated with each of the steps, the step data including track data that associates each of the steps with one track of a plurality of tracks, the track corresponding to one of a plurality of assignable entities responsible for performing the step(s) in the track, the unified workflow proceeds over steps in more than one track;
a workflow manager configured to manage the unified workflow; and
a presentation layer configured to output information regarding the unified workflow to a display medium.

21. A computer-readable medium storing instructions for managing workflows, which when executed by a processor, causes a computer to function as:
a business logic layer including:
a workflow creator configured to define a unified workflow for performing a task by combining steps of at least two workflows for performing the task, the unified workflow having associated workflow data including (i) step data associated with each of the steps, the step data including track data that associates each of the steps with one track of a plurality of tracks, the track corresponding to one of a plurality of assignable entities responsible for performing the step(s) in the track, and (ii) business rules, the workflow data having been imported from a non-uniform data format and converted to a uniform data format,
a business rules engine configured to select and apply business rules to the workflow data during an execution of the unified workflow such that an execution of at least one step is dependent on the execution of at least one other step, and
a workflow manager configured to manage the unified workflow based on the selected and applied business rules during the execution of the unified workflow; and
a presentation layer configured to output information regarding the managed unified workflow to a display medium.

22. A method of managing a unified workflow for performing a task, the unified workflow combining steps of at least two workflows, the unified workflow having associated workflow data including step data associated with each of the steps, the step data including track data that associates each of the steps with one track of a plurality of tracks and the track corresponding to one of a plurality of assignable entities responsible for performing the step(s) in the track, the method comprising:
assigning to the step data at least one of (i) a trigger condition which, when met, causes an associated step to be triggered, and (ii) a termination condition which, when met, causes the associated step to be terminated;
linking the associated step with one or more other steps based on the assignment of step data.

23. The method of claim 22, further comprising
reassigning at least one step to a different track.

24. The method of claim 23, wherein
reassigning at least one step is based on one of the step data of another step, and the track data of another track and the track data of the track including the at least one step.

25. The method of claim 22, wherein
managing the unified work flow includes
reassigning the trigger condition and/or the termination condition of the associated step in the track to be associated with the one or more other tracks.

26. The method of claim 22, wherein
managing the unified work flow includes
eliminating at least one step of similar steps in one or more tracks.

27. The method of claim 22, wherein
managing the unified work flow includes
consolidating a plurality of steps into a single step.
